(19) United States
(12) Patent Application Publication
(10) Pub. No.: US 2026/0277650 A1
(43) Pub. Date: Sep. 17, 2026

(54) Application and/or Virtual Machine Migration based on Source Sizing and Target Shaping

(71) Applicant: Oracle International Corporation, Redwood Shores, CA (US)

(72) Inventors: James C. EARNESTY, JR., Concord, NC (US); Mary Allgood MELGAARD, Sarasota, FL (US); Inderpal S. TAHIM, Flower Mound, TX (US); Rohan NAIK, Austin, TX (US)

(21) Appl. No.: 19/076,234

(22) Filed: Mar. 11, 2025

(51) Int. Cl. G06F 9/455

(52) U.S. Cl. CPC G06F 9/45558; G06F 2009/4557

(57) ABSTRACT

Embodiments plan, schedule, and execute digital element migration between a source system and a target system. For example, a source system can include a number of source assets that operate digital elements, such as applications and/or virtual machines. Implementations can perform digital element migration using digital element sizing and target architecture shaping. For example, the digital elements can be sized to determine resource requirements for the digital elements. The sized digital elements can then support shaping of virtual machine instances for the target system, mapping of the digital elements to the virtual machine instances for the target system, and migration scheduling. Embodiments include a dynamic process manager that provides an extensible framework for migration workflows.

### FIELD

The embodiments of the present disclosure generally relate to application and/or virtual machine migration based on source sizing and target shaping.

### BACKGROUND

Due to the numerous complexities of system management, application migration presents a multifaceted challenge. For instance, applications can be implemented via variety of system architectures and may include interactions with other applications and/or databases. In addition, many applications comprise operating conditions, such as downtime requirements, that place additional constraints on a migration workflow. Further, target system implementations can vary widely, and are often subject to various organizational preferences or constraints. These are merely examples, and a number of additional complexities have made effective application migration a challenging component of overall system migration.

### SUMMARY

The embodiments of the present disclosure are generally directed to systems and methods for performing digital migration of applications and/or virtual machines using source sizing and target shaping. Information about a plurality of source digital elements associated with a source system can be received, the information comprising processor utilization for the source digital elements and memory utilization for the source digital elements, where the source digital elements comprise applications and/or virtual machines. The source digital elements can be sized according to the processor utilization and memory utilization to determine resource requirements at a target system. A shape for a target architecture based on the resource requirements for the source digital elements can be generated, the shape comprising a plurality of target virtual machine instances implemented by target hardware components and/or target service components of the target architecture, where the target architecture is configured to receive migration of the source digital elements and operate target digital elements, via the target virtual machine instances, corresponding to the source digital elements.

Features and advantages of the embodiments are set forth in the description which follows, or will be apparent from the description, or may be learned by practice of the disclosure.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a system for migrating digital elements from a source system to a target system according to an example embodiment.

FIG. 2 illustrates a block diagram of a computing device operatively coupled to a system according to an example embodiment.

FIG. 3 illustrates a system for migrating digital elements from a source system to a target system using digital element sizing and system interrogation according to an example embodiment.

FIG. 4 illustrates a system for migrating digital elements from a source system to a target system using digital element sizing and target system mapping according to an example embodiment.

FIG. 5 illustrates a system for migrating digital elements from a source system to a target system using a migration schedule according to an example embodiment.

FIG. 6 illustrates a system for migrating digital elements from a source system to a target system using generated commands according to an example embodiment.

FIG. 7 illustrates system components for migrating digital elements via a migration server according to an example embodiment.

FIG. 8 illustrates a flow diagram of a dynamic process manager according to an example embodiment.

FIG. 9A illustrates a diagram of a user interface for mapping digital element parameters to a target architecture according to an example embodiment.

FIGS. 9B and 9C illustrate a flow diagram for consolidating digital elements to pools of capacity at target architecture according to an example embodiment.

FIG. 10 illustrates a diagram of a user interface for assigning values for a migration scheduling workflow according to an example embodiment.

FIG. 11 illustrates a flow diagram performing digital migration of applications and/or virtual machines using source sizing and target shaping according to an example embodiment.

FIG. 12 illustrates a flow diagram for performing digital migration of applications and/or virtual machines using consolidation according to an example embodiment.

FIG. 13 illustrates a flow diagram for performing digital migration of applications and/or virtual machines using workflow definitions.

FIG. 14 illustrates a flow diagram for performing rule-based scheduling and migration of applications and/or virtual machines based on complexity and weight according to an example embodiment.

### DETAILED DESCRIPTION

Embodiments plan, schedule, and execute digital element migration between a source system and a target system. For example, a source system can include a number of source assets (e.g., one or a mix of on-premise, cloud, Oracle®, and the like) that operate digital elements, such as applications and/or virtual machines. Migration of the digital elements from the source system to a new system (e.g., target system) can sometimes be performed, for example to improve operational efficiency or for any other suitable purpose.

In some implementations, the source system can be implemented by an enterprise or organization, and the digital elements can provide software functionality for the enterprise or organization. For example, once the digital elements are migrated from the source system to the target system, this functionality can be accomplished via operating the digital elements at the target system. Examples of such software applications/functionality include accounting, inventory management, information technology, back-end data services, cloud hosting for a web application, software as a service, infrastructure as a service, platform as a service, product specific functionality, service specific functionality, identity management services, and any other suitable software functionality.

Implementations can perform the digital element migration using digital element sizing and target architecture shaping. For example, the digital elements can be sized to determine resource requirements for the digital elements. The sized digital elements can then support shaping of virtual machine instances for the target system, mapping of the digital elements to the virtual machine instances for the target system, and migration scheduling.

In some implementations, new migration workflows can be customized via provided definitions. For example, the provided definitions can include script indicators, parameters for script indicators, and an organization of sub-components of the new migration workflow. The definitions can then be processed to create intermediate versions (e.g., structured data representation(s), sets of commands, and the like) to execute the migration workflow. Migrating the source digital elements to the target virtual machines instances can be accomplished, in part, by executing the newly defined migration workflow.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

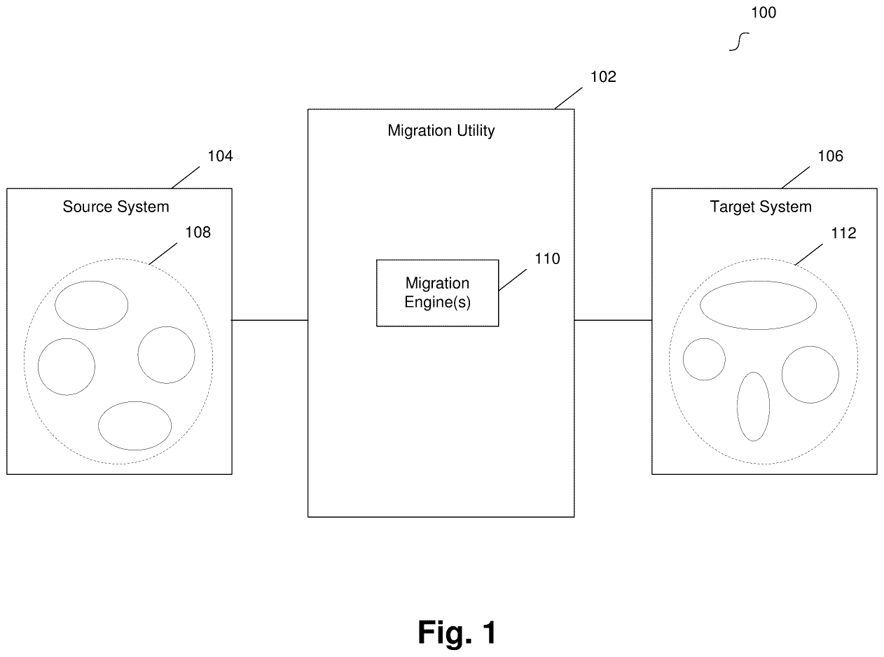

FIG. 1 illustrates a system for migrating digital elements from a source system to a target system according to an example embodiment. Diagram 100 illustrates migration utility 102, source system 104, target system 106, source architecture 108, migration engine(s) 110, and target architecture 112. Migration utility 102 can migrate digital elements, such as applications and/or virtual machines, from source architecture 108 to target architecture 112. For example, migration utility 102 can determine sizes for the digital elements of source architecture 108 and shape target architecture 112 according to the sizing of the source digital elements. For example, target architecture 112 can comprise virtual machine hardware and/or a plurality of virtual machine instances, such as instances with varying operating characteristics (e.g., processing power, disk size, memory size, security, etc.). In some implementations, the computing resources of target architecture 112 are provided by hardware components (e.g., specific hardware device(s) and/or service component (e.g., logical portions of computing resource from a cloud system). Migration utility 102 can define virtual machine instances for target architecture 112 according to the sized source digital elements, for example to generate a shape for target architecture 112 that corresponds to the source digital elements that will be migrated to this architecture.

Migration utility 102 can also consolidate the source digital elements, or assign each of the source digital elements to a particular hardware components and/or service component of target architecture 112. In some implementations, consolidation rules that match digital element parameters to hardware components and/or service components can be defined, and migration utility 102 can assign a particular source digital element to a pool of capacity at target architecture 112 (e.g., implemented via hardware components and/or service components) with matching parameters and available capacity. Migration utility 102 can generate a number of different scenarios that map source digital elements to particular hardware components and/or service components of target architecture 112, and at least one of these scenarios can be selected for the migration.

Migration utility 102 can also generate a migration schedule for migrating source digital elements from source architecture 108 to target architecture 112. For example, the schedule can comprise periods of time (e.g., individual weeks), and the source digital elements can be assigned to particular periods of time. Migration utility 102 can assign digital elements to particular periods of time based on scheduling rules. For example, the source digital elements can be classified to predetermined migration complexity classification and weights can be assigned to each of the predetermined classifications. Migration utility 102 can then utilize scheduling rules, including a weight threshold and/or number of migrations threshold for each period of time, to assign digital elements to periods of time.

Once the migration of source digital elements from source architecture 108 to target architecture 112 is planned, such as after the shape of target architecture 112 is generated, the source digital elements are mapped to target architecture 112, and the source digital elements are assigned to periods of time according to a migration schedule, migration engine(s) 110 can perform the migration of the digital elements. For example, the virtual machine instances of target architecture 112 can be configured to receive and operate the digital elements via migration performed by migration engine(s) 110 according to the defined migration schedule.

Example components that comprise an architecture for source system 104 and/or target system 106 include platforms such as Oracle® Cloud Infrastructure (“OC”), Oracle® Database Cloud Service (“ODBCS”), Oracle® Exadata Cloud Service (“ExaCS”), Oracle® Exadata Cloud at Customer (“ExaCC”), other Oracle® Exadata Cloud Machine platforms, Oracle® Real Application Clusters (“RAC”) or other grid computing platforms, other Oracle® cloud platforms, other Oracle® on-premise platforms, as well as any suitable cloud based, on-premise, and/or grid computing platforms (e.g., from other suitable hardware, software, or platform providers)

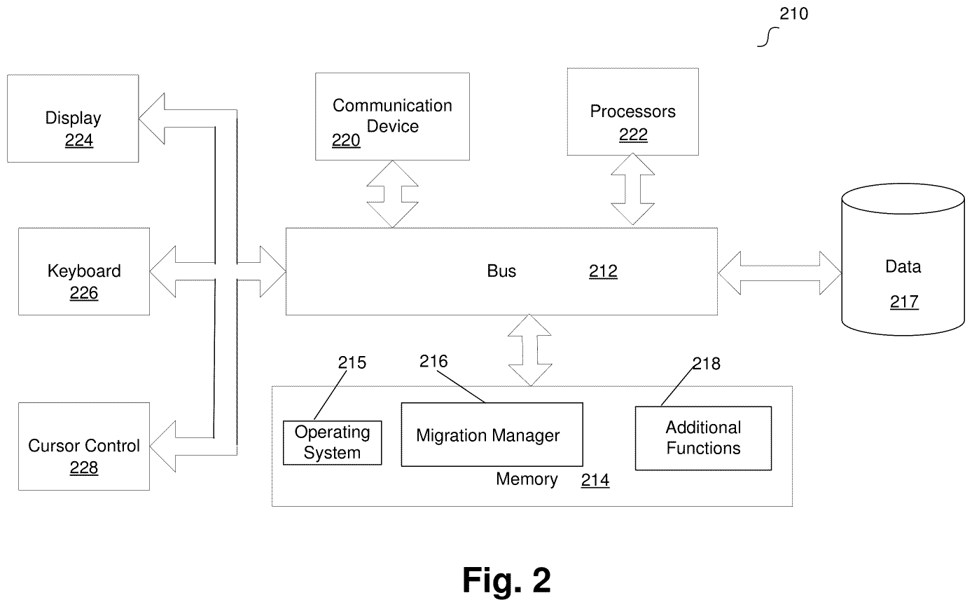

FIG. 2 is a block diagram of a computer server/system 200 in accordance with embodiments. All or portions of system 200 may be used to implement any of the elements shown in FIG. 1. As shown in FIG. 2, system 200 may include a bus device 212 and/or other communication mechanism(s) configured to communicate information between the various components of system 200, such as processor 222 and memory 214. In addition, communication device 220 may enable connectivity between processor 222 and other devices by encoding data to be sent from processor 222 to another device over a network (not shown) and decoding data received from another system over the network for processor 222.

For example, communication device 220 may include a network interface card that is configured to provide wireless network communications. A variety of wireless communication techniques may be used including infrared, radio, Bluetooth®, Wi-Fi, and/or cellular communications. Alternatively, communication device 220 may be configured to provide wired network connection(s), such as an Ethernet connection.

Processor 222 may include one or more general or specific purpose processors to perform computation and control functions of system 200. Processor 222 may include a single integrated circuit, such as a micro-processing device, or may include multiple integrated circuit devices and/or circuit boards working in cooperation to accomplish the functions of processor 222. In addition, processor 222 may execute computer programs, such as operating system 215, migration engine 216, and other applications 218, stored within memory 214.

System 200 may include memory 214 for storing information and instructions for execution by processor 222. Memory 214 may contain various components for retrieving, presenting, modifying, and storing data. For example, memory 214 may store software modules that provide functionality when executed by processor 222. The modules may include an operating system 215 that provides operating system functionality for system 200. The modules can include an operating system 215, migration engine 216 configured to perform migration planning, scheduling, and execution, as well as other applications modules 218. Operating system 215 provides operating system functionality for system 200. In some instances, migration engine 216 may be implemented as an in-memory configuration. In some implementations, when system 200 executes the functionality of migration engine 216, it implements a non-conventional specialized computer system that performs the functionality disclosed herein.

Non-transitory memory 214 may include a variety of computer-readable medium that may be accessed by processor 222. For example, memory 214 may include any combination of random access memory (“RAM”), dynamic RAM (“DRAM”), static RAM (“SRAM”), read only memory (“ROM”), flash memory, cache memory, and/or any other type of non-transitory computer-readable medium. Processor 222 is further coupled via bus 212 to a display 224, such as a Liquid Crystal Display (“LCD”). A keyboard 226 and a cursor control device 228, such as a computer mouse, are further coupled to communication device 212 to enable a user to interface with system 200.

In some embodiments, system 200 can be part of a larger system. Therefore, system 200 can include one or more additional functional modules 218 to include the additional functionality. Other applications modules 218 may include the various modules of Oracle® Cloud Infrastructure, Oracle® Cloud Platform, and/or Oracle® Cloud Applications, for example.

A database 217 is coupled to bus 212 to provide centralized storage for modules 216 and 218 and to store, for example, data received migration engine 216 or other data sources. Database 217 can store data in an integrated collection of logically-related records or files. Database 217 can be an operational database, an analytical database, a data warehouse, a distributed database, an end-user database, an external database, a navigational database, an in-memory database, a document-oriented database, a real-time database, a relational database, an object-oriented database, a non-relational database, a NoSQL database, Hadoop® distributed file system (“HFDS”), or any other database known in the art.

Although shown as a single system, the functionality of system 200 may be implemented as a distributed system. For example, memory 214 and processor 222 may be distributed across multiple different computers that collectively represent system 200. In one embodiment, system 200 may be part of a device (e.g., smartphone, tablet, computer, etc.). In an embodiment, system 200 may be separate from the device, and may remotely provide the disclosed functionality for the device. Further, one or more components of system 200 may not be included. For example, for functionality as a user or consumer device, system 200 may be a smartphone or other wireless device that includes a processor, memory, and a display, does not include one or more of the other components shown in FIG. 2, and includes additional components not shown in FIG. 2, such as an antenna, transceiver, or any other suitable wireless device component.

In general, the industry relies on a set of disparate toolsets for migration that are not integrated nor optimized to work together to enable mass provisioning and migrations. Embodiments can automate and perform mass migrations of storage, networks, virtual machines, databases, applications, and webservers to cloud and on-premise targets. For example, a host of engines and modules working in tandem integrate and automate relevant migration processes to include discovery, analysis, scheduling, consolidation, mapping, provisioning, and migration, with a defined set of rules and target enhancements.

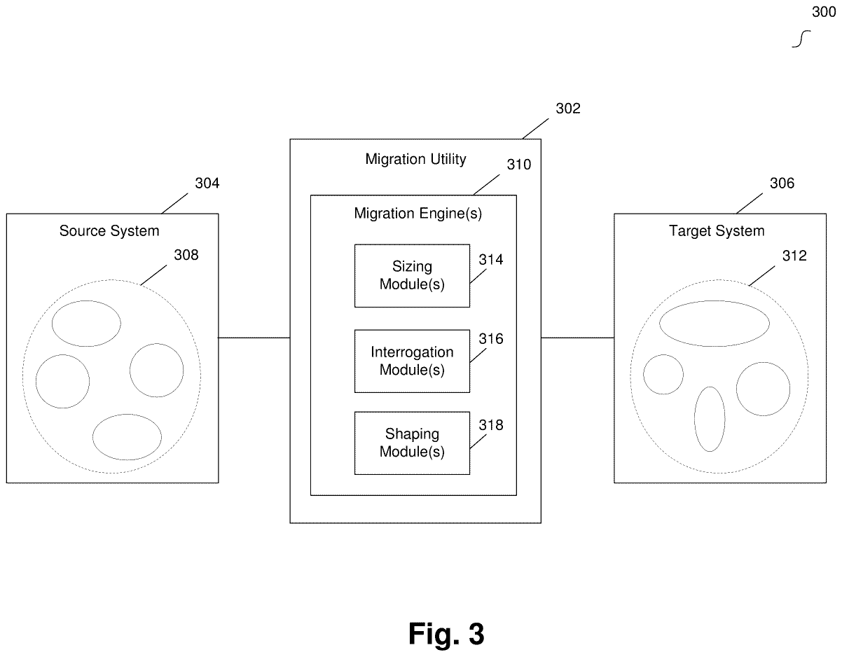

FIG. 3 illustrates a system for migrating digital elements from a source system to a target system using digital element sizing and system interrogation according to an example embodiment. Diagram 300 illustrates migration utility 302, source system 304, target system 306, source architecture 308, migration engine(s) 310, target architecture 312, sizing module(s) 314, interrogation module(s) 316, and shaping module(s) 318.

In some implementations, information about digital elements of source system 304, such as applications, virtual machines, and related databases, can be loaded to migration utility 302. For example, a list of applications, databases, and virtual machines representing the inventory of source system 304 (e.g., a load sheet) containing contacts, business requirements and characteristics for these elements can be loaded. In some implementations, a manager utility (e.g., Oracle Enterprise Manager) can determine the load sheet information. For example, a list of databases, applications, and virtual machines containing additional technical details for each digital element type can be loaded via the manager utility.

In another example, this information can be populated manually via a load sheet, as well as via completing an online questionnaire by a user of source system 304. For example, a load sheet based inventory can be used for large numbers of applications, databases, and virtual machines. In another example, a user can input, via an online questionnaire, the inventory online. An example summary of the loaded information for digital elements includes:
Total Virtual Machine Count
Environment: NONPROD, PROD, DR
Virtual machine count per environment
Average virtual machine size grouping (GB): Per environment and virtual machine count
Requested Cutover Time: The amount of downtime requested per environment, virtual machine count, and virtual machine size grouping.

In some implementations, interrogation module(s) 316 can execute reverse engineering scripts to determine resource requirements for digital elements of source architecture 308. For example, interrogation module(s) 316 can analyze applications and virtual machines (e.g., via Oracle Enterprise Manager, an Oracle configuration management and monitoring tool) to capture processor usage, memory usage, and storage usage requirements for each digital element, along with detailed environment specifications.

The following example workflow can be executed to reverse engineer resource requirements for digital elements of source architecture 308:
Dump non-container, container and pluggable databases and current resource profiles to individual csv files that can be loaded via the Load and Classification.
Dump non-container, container and pluggable databases and historical resource profiles to show growth rates over time to a common csv file that can be loaded via the Load and Classification.
The workflow is executed as follows and produces the following example output:
[oracle@emcc:~/oem]$ sh M360_OEM_EXTRACT_V5_0_0_0.sh
Enter Environment File Path:/home/oracle/emrep.env
OEM is running on PDB [Y/N]:N
1. Full Load Sheet—Estate Planning and Analysis
2. Minimal Required Load Sheet—Estate Planning and Analysis->CPU, SGA,
DB SIZE & DB Version
3. Statistical Distribution Load sheet—Estate Planning and Analysis □ app wise distribution
Select type of analysis 1 or 2 or 3 above: 1
###########M360 Inventory and OEM Extraction process is in progress###########
#####Start OEM Extract Connect DB & Create Temp Tables: Tue Feb 28 10:04:59 GMT 2023######
Table Creation Done: Tue Feb 28 10:04:59 GMT 2023
OEM Data Extract For CDBs & PDBs Done & Zip in Process: Tue Feb 28 10:05:27 GMT 2023
*** Business Details ***
m360_inventory_cdb_v50_20230228_10_04.csv
m360_inventory_pdb_v50_20230228_10_04.csv
*** Technical Details ***
m360_oem_extract_v42_20230228_10_04.csv
m360_oem_extract_v50_20230228_10_04.csv
*** Historical Data ***
m360_oem_history_data_v50_20230228_10_04.csv
Files (Inventory and OEM data files) are generated successfully . . . : Tue Feb 28 10:05:27 GMT 2023

The loaded information can be cleaned and/or validated by migration utility 302. For example, the following functionality can be performed to clean and/or validate the loaded information about the digital elements:

### Data Cleaning:

Strip leading and trailing white space from all fields.
Convert to upper case for all fields that do not have to be case-sensitive
Convert fields with only white space to nulls
Strip characters from numeric fields where they exist. For example, convert ‘1,024’ to ‘1024’
Strip domains from hostnames
Ensure yes or no columns are cleaned consistently to ‘y’ or ‘n’

### Validation:

Ensure host and database names are not null
Ensure database name is valid oracle length
Ensure spreadsheet specified environments, data centers, service tiers, cutover times, and security zones are valid values
Ensure all numeric columns are null or valid integers
Ensure database transaction types are valid values as defined in the load spreadsheet
Ensure yes or no columns are not filled with values that do not mean yes/no
Ensure no duplicate databases are listed in the spreadsheet
Ensure no databases listed in the spreadsheet are already loaded

In some implementations, sizing module(s) 314 can determine sizing and resource requirements for each digital element, such as operating attributes for applications and/or virtual machines. For example, using load sheet information and/or a reverse engineering workflow, sizing module(s) 314 can determine the following example operating attributes for each source digital element: disk size, production status, processor utilization, and RAM memory usage. These example attributes can represent a sizing for each source digital element. Other suitable attributes that sizing module(s) 314 can determine to size digital elements includes: application/VM size (e.g., image of application), size of data tier for application/VM for migration, number of concurrent users (e.g., range), number of affiliated/dependent databases and/or aggregate size of these databases, or any other suitable attributes. In some implementations, sizing module(s) 314 can generate a sizing for each source digital element according to its attributes (e.g., one or more of disk size, processor utilization, production status, RAM usage, number of database, number of concurrent users, application/VM size, data tier size, any combination thereof, and the like.).

In some implementations, migration utility 302 can classify these source digital elements into predefined migration complexity classification. An example mapping that maps characteristics of applications and/or virtual machines to predefined migration complexity classifications is below:

| COMPLEXITY | DISK_L | DISK _H | PROD_STATUS | RAM_L | RAM_H | REQ_CUTOVER_TI |
|---|---|---|---|---|---|---|
| COMPLEX | 10241 | 20480 | NONPROD | 257 | 512 | >60 MINS AND <= 04 |
| | | | | | | HOURS |
| VERY | 20481 | 100000000 | NONPROD | 513 | 2048 | >60 MINS AND <= 04 |
| COMPLEX | | | | | | HOURS |
| VERY | 0 | 100 | NONPROD | 0 | 64 | >04 HOURS AND <= |
| SIMPLE | | | | | | 24 HOURS |
| SIMPLE | 101 | 5120 | NONPROD | 65 | 128 | >04 HOURS AND <= |
| | | | | | | 24 HOURS |
| AVERAGE | 5121 | 10240 | NONPROD | 129 | 256 | >04 HOURS AND <= |
| | | | | | | 24 HOURS |
| COMPLEX | 10241 | 20480 | NONPROD | 257 | 512 | >04 HOURS AND <= |
| | | | | | | 24 HOURS |
| VERY | 20481 | 100000000 | NONPROD | 513 | 2048 | >04 HOURS AND <= |
| COMPLEX | | | | | | 24 HOURS |
| VERY | 0 | 100 | NONPROD | 0 | 64 | >24 HOURS AND <= |
| SIMPLE | | | | | | 48 HOURS |
| SIMPLE | 101 | 5120 | NONPROD | 65 | 128 | >24 HOURS AND <= |
| | | | | | | 48 HOURS |
| AVERAGE | 5121 | 10240 | NONPROD | 129 | 256 | >24 HOURS AND <= |
| | | | | | | 48 HOURS |
| COMPLEX | 10241 | 20480 | NONPROD | 257 | 512 | >24 HOURS AND <= |
| | | | | | | 48 HOURS |
| VERY | 20481 | 100000000 | NONPROD | 513 | 2048 | >24 HOURS AND <= |
| COMPLEX | | | | | | 48 HOURS |
| VERY | 0 | 100 | NONPROD | 0 | 64 | >30 MINS AND <= 60 |
| SIMPLE | | | | | | MINS |
| SIMPLE | 101 | 5120 | NONPROD | 65 | 128 | >30 MINS AND <= 60 |
| | | | | | | MINS |
| AVERAGE | 5121 | 10240 | NONPROD | 129 | 256 | >30 MINS AND <= 60 |
| | | | | | | MINS |
| COMPLEX | 10241 | 20480 | NONPROD | 257 | 512 | >30 MINS AND <= 60 |
| | | | | | | MINS |
| VERY | 20481 | 100000000 | NONPROD | 513 | 2048 | >30 MINS AND <= 60 |
| COMPLEX | | | | | | MINS |
| VERY | 0 | 100 | NONPROD | 0 | 64 | >48 HOURS |
| SIMPLE | | | | | | |
| SIMPLE | 101 | 5120 | NONPROD | 65 | 128 | >48 HOURS |
| AVERAGE | 5121 | 10240 | NONPROD | 129 | 256 | >48 HOURS |
| COMPLEX | 10241 | 20480 | NONPROD | 257 | 512 | >48 HOURS |
| VERY | 20481 | 100000000 | NONPROD | 513 | 2048 | >48 HOURS |
| COMPLEX | | | | | | |
| VERY | 0 | 100 | PROD | 0 | 64 | >0 MINS AND <= 30 |
| SIMPLE | | | | | | MINS |
| SIMPLE | 101 | 5120 | PROD | 65 | 128 | >0 MINS AND <= 30 |
| | | | | | | MINS |
| AVERAGE | 5121 | 10240 | PROD | 129 | 256 | >0 MINS AND <= 30 |
| | | | | | | MINS |
| COMPLEX | 10241 | 20480 | PROD | 257 | 512 | >0 MINS AND <= 30 |
| | | | | | | MINS |
| VERY | 20481 | 100000000 | PROD | 513 | 2048 | >0 MINS AND <= 30 |
| COMPLEX | | | | | | MINS |
| VERY | 0 | 100 | PROD | 0 | 64 | >60 MINS AND <= 04 |
| SIMPLE | | | | | | HOURS |
| SIMPLE | 101 | 5120 | PROD | 65 | 128 | >60 MINS AND <= 04 |
| | | | | | | HOURS |
| AVERAGE | 5121 | 10240 | PROD | 129 | 256 | >60 MINS AND <= 04 |
| | | | | | | HOURS |
| COMPLEX | 10241 | 20480 | PROD | 257 | 512 | >60 MINS AND <= 04 |
| | | | | | | HOURS |
| VERY | 20481 | 100000000 | PROD | 513 | 2048 | >60 MINS AND <= 04 |
| COMPLEX | | | | | | HOURS |
| VERY | 0 | 100 | PROD | 0 | 64 | >04 HOURS AND <= |
| SIMPLE | | | | | | 24 HOURS |
| SIMPLE | 101 | 5120 | PROD | 65 | 128 | >04 HOURS AND <= |
| | | | | | | 24 HOURS |
| AVERAGE | 5121 | 10240 | PROD | 129 | 256 | >04 HOURS AND <= |
| | | | | | | 24 HOURS |
| COMPLEX | 10241 | 20480 | PROD | 257 | 512 | >04 HOURS AND <= |
| | | | | | | 24 HOURS |
| VERY | 20481 | 100000000 | PROD | 513 | 2048 | >04 HOURS AND <= |
| COMPLEX | | | | | | 24 HOURS |
| VERY | 0 | 100 | PROD | 0 | 64 | >24 HOURS AND <= |
| SIMPLE | | | | | | 48 HOURS |
| SIMPLE | 101 | 5120 | PROD | 65 | 128 | >24 HOURS AND <= |
| | | | | | | 48 HOURS |
| AVERAGE | 5121 | 10240 | PROD | 129 | 256 | >24 HOURS AND <= |
| | | | | | | 48 HOURS |
| COMPLEX | 10241 | 20480 | PROD | 257 | 512 | >24 HOURS AND <= |
| | | | | | | 48 HOURS |
| VERY | 20481 | 100000000 | PROD | 513 | 2048 | >24 HOURS AND <= |
| COMPLEX | | | | | | 48 HOURS |
| VERY | 0 | 100 | PROD | 0 | 64 | >30 MINS AND <= 60 |
| SIMPLE | | | | | | MINS |
| SIMPLE | 101 | 5120 | PROD | 65 | 128 | >30 MINS AND <= 60 |
| | | | | | | MINS |
| AVERAGE | 5121 | 10240 | PROD | 129 | 256 | >30 MINS AND <= 60 |
| | | | | | | MINS |
| COMPLEX | 10241 | 20480 | PROD | 257 | 512 | >30 MINS AND <= 60 |
| | | | | | | MINS |
| VERY | 20481 | 100000000 | PROD | 513 | 2048 | >30 MINS AND <= 60 |
| COMPLEX | | | | | | MINS |
| VERY | 0 | 100 | PROD | 0 | 64 | >48 HOURS |
| SIMPLE | | | | | | |
| SIMPLE | 101 | 5120 | PROD | 65 | 128 | >48 HOURS |
| AVERAGE | 5121 | 10240 | PROD | 129 | 256 | >48 HOURS |
| COMPLEX | 10241 | 20480 | PROD | 257 | 512 | >48 HOURS |
| VERY | 20481 | 100000000 | PROD | 513 | 2048 | >48 HOURS |
| COMPLEX | | | | | | |
| VERY | 0 | 100 | NONPROD | 0 | 64 | >0 MINS AND <= 30 |
| SIMPLE | | | | | | MINS |
| SIMPLE | 101 | 5120 | NONPROD | 65 | 128 | >0 MINS AND <= 30 |
| | | | | | | MINS |
| AVERAGE | 5121 | 10240 | NONPROD | 129 | 256 | >0 MINS AND <= 30 |
| | | | | | | MINS |
| COMPLEX | 10241 | 20480 | NONPROD | 257 | 512 | >0 MINS AND <= 30 |
| | | | | | | MINS |
| VERY | 20481 | 100000000 | NONPROD | 513 | 2048 | >0 MINS AND <= 30 |
| COMPLEX | | | | | | MINS |
| VERY | 0 | 100 | NONPROD | 0 | 64 | >60 MINS AND <= 04 |
| SIMPLE | | | | | | HOURS |
| SIMPLE | 101 | 5120 | NONPROD | 65 | 128 | >60 MINS AND <= 04 |
| | | | | | | HOURS |
| AVERAGE | 5121 | 10240 | NONPROD | 129 | 256 | >60 MINS AND <= 04 |
| | | | | | | HOURS |

In another example, migration utility 302 can classify source digital elements into predefined migration complexity classifications according to the following example rule set:

| Very Simple | Simple |
|---|---|
| An Application/VM is considered | An Application/VM is |
| very simple if the following | considered simple |
| conditions are met: | if the following conditions are met: |
| The cutover window is 48 hrs or | The cutover window is 24 hrs or |
| greater | greater |
| Application has a low number of | Application has a low number of |
| concurrent users (e.g., less than | concurrent users (e.g., less than |
| a concurrent users threshold) | a threshold). |
| App has less than a first | App has less than a second |
| threshold number of interfaces | threshold number of interfaces |
| (e.g., 1, 2, 3, etc.) | (e.g., 5, 6, 7, etc.) |
| Application has no replication | Application has less than a |
| processes | second threshold number of DBs |
| Application has less than a | (e.g., 2 DBs). |
| threshold number of DBs (e.g., 1 | App does not require |
| DB). | Performance Testing |
| App does not require | App does not require Resiliency |
| Performance Testing | Testing |
| App does not require Resiliency | |
| Testing | |

| Average | Complex |
|---|---|
| An Application/VM is considered | An Application/VM is considered |
| average if the following conditions | complex if the following |
| are met: | conditions are met: |
| Application VM size is less | Application VM size is greater than |
| than a threshold (e.g., 300 | 300 GB a threshold (e.g., 300 GB) |
| GB) | Data residing on app tier for |
| Data residing on app tier for | migration is less than a threshold |
| migration less than threshold | (e.g., 100 GB) |
| (e.g., 100 GB) | And any of the following |
| And any of the following | conditions are met |
| conditions are met | The cutover window is 24 hrs or |
| The cutover window is 24 hrs | less |
| or less | Uni-directional replication is |
| Uni-directional replication is | required for App migration |
| required for App migration | Fallback (active/active- |
| App has less than threshold | GG/Streams) solution is required |
| number of interfaces (e.g., 10, | App has less than threshold |
| 12, etc.) | number of interfaces (e.g., 20, 22, |
| Application has less than | etc.) |
| threshold number of DBs | Application has less than threshold |
| (e.g., 10, 12, etc.). | number of DBs (e.g., 10, 12, etc.). |
| App does not require | App does not require Performance |
| Performance Testing | Testing |
| App does not require | App does not require Resiliency |
| Resiliency Testing | Testing |

Very Complex

An Application/VM is considered very complex
if the following conditions are met
Application size is greater than threshold (e.g., 300 GB)
Data residing on app tier for migration less than threshold (e.g., 100 GB)
The cutover window is 0 (Zero downtime)
And any of the following conditions are met
Fallback (active/active-GG/Streams) solution is required
Bi-Directional replication is required
Uni-directional replication is required for App migration
Fallback (active/active-GG/Streams) solution is required
App has more than threshold number of interfaces (e.g., 20, 22, etc.)
Application has more than threshold number of DBs (e.g., 10, 12, etc.).
App does not require Performance Testing
App does not require Performance Testing

In some implementations, migration utility 302 can assign a migration method to the classified digital elements. Below are example groupings for mapping migration techniques to digital element characteristics:

| REQ_CUTOVER_TIME | Migration Technique |
|---|---|
| >0 MINS AND <= 30 MINS | rwvmmigration/sync |
| >30 MINS AND <= 60 MINS | rwvmmigration/sync |
| >60 MINS AND <= 04 HOURS | rwvmmigration |
| >04 HOURS AND <= 24 HOURS | rwvmmigration |
| >24 HOURS AND <= 48 HOURS | rwvmmigration |
| >48 HOURS | rwvmmigration |

In some implementations, shaping module(s) 318 can determine a shape for target architecture 312, such as register virtual machine hardware and/or virtual machine instance(s) for the target architecture. For example, details about the virtual machine instances for target architecture 312 can be input, such as by a user for target architecture 312, via an online page, load sheet, or via any other suitable source. In another example, characteristics of a designed set of virtual machine instances for target architecture 312 can be pulled via a management tool, such as Oracle Cloud Infrastructure (OCI) Tenancy details. In this example, one or more hardware components (e.g., hardware device(s)) and/or service components (e.g., logical chunks of computing resources from a cloud system) can be selected for target architecture 312, such as by a user, in accordance with the sizing for digital elements from source system 304, and the like.

In some implementations, interrogation module(s) 316 can interrogate target system 306 to determine attributes of target architecture 312, such as the characteristics of virtual machine hardware and/or virtual machine instances that comprise the target architecture. For example, when target systems have already been deployed and/or comprise characteristics unknown to migration utility 302, a crawler can be executed to reverse engineer the targets for loading, such as via execution, by interrogation module(s) 316, of the reverse engineering script(s). When this process is completed, the systems can be loaded into a target registration section such that source system digital elements can be mapped to the target architecture 312.

In some implementations, target architecture 312 can comprise instances of service components, hardware components, or any combination of these. For example, a service component can comprise a computing resources provided via a cloud service provider. A service component can provide a defined set of computing services for applications and/or virtual machines, such as range of processor capacity, range of disk space, range of RAM, degree of dynamic upscaling in response to load, and the like. A service component can comprise service tiers, such as low, medium, high, or any other suitable tiers. These different tiers can correspond to different levels of computing resources. In some implementations, target architecture 312 can include one or more instances of service components, such as service components that each correspond to predefined level(s) of computing services.

In another example, hardware components can comprise hardware with a defined set of characteristics (e.g., disk space, RAM, processor capacity, etc.), such as a server or other suitable computing device. Thus, target architecture 312 can comprise one or more service components defined by predefined level(s) of computing services and one or more hardware components defined by set(s) of hardware characteristics. In some implementations, service component(s) may be implemented across any suitable devices of a cloud service provider, while hardware components comprise dedicated computing resources at specific hardware (e.g., server or other computing device). In some implementations, service component(s) may comprise elements of computing services, such as scaling up disk space, RAM, processing capacity, etc. in response to peak capacity, failover contingencies, redundancy policies, and the like, that hardware component(s) do not provide.

Shaping module(s) 318 can determine a shape for target architecture 312 based on the service component(s) and/or hardware component(s) defined for the target. For example, multiple instances of service components (each corresponding to a predefined level of computing services) and/or multiple instances of hardware components (each corresponding to a defined set of hardware characteristics) can be determined (e.g., in response to interrogation) and/or selected (e.g., via input) for target architecture 312, and the shape of the architecture can comprise these determined/selected service components and/or hardware components.

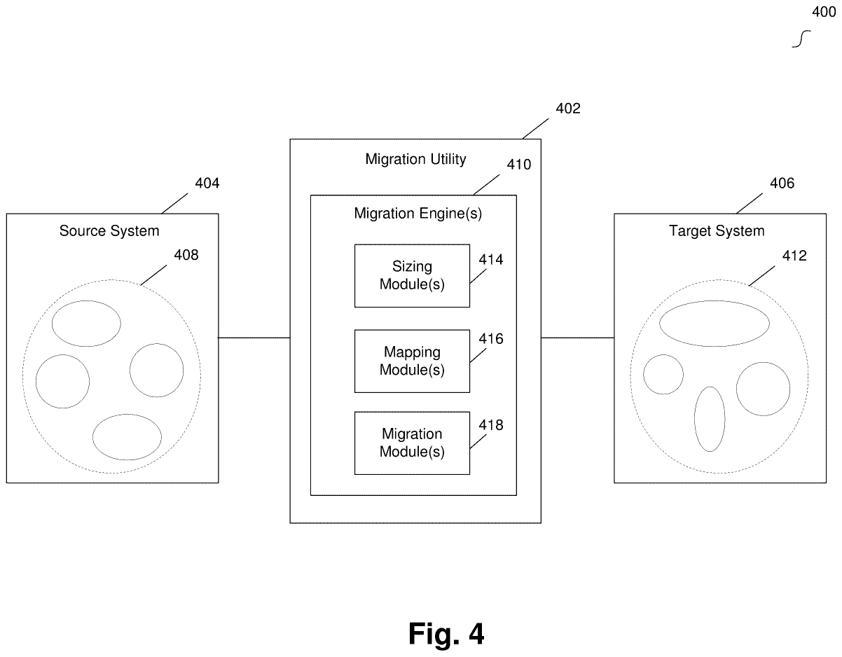

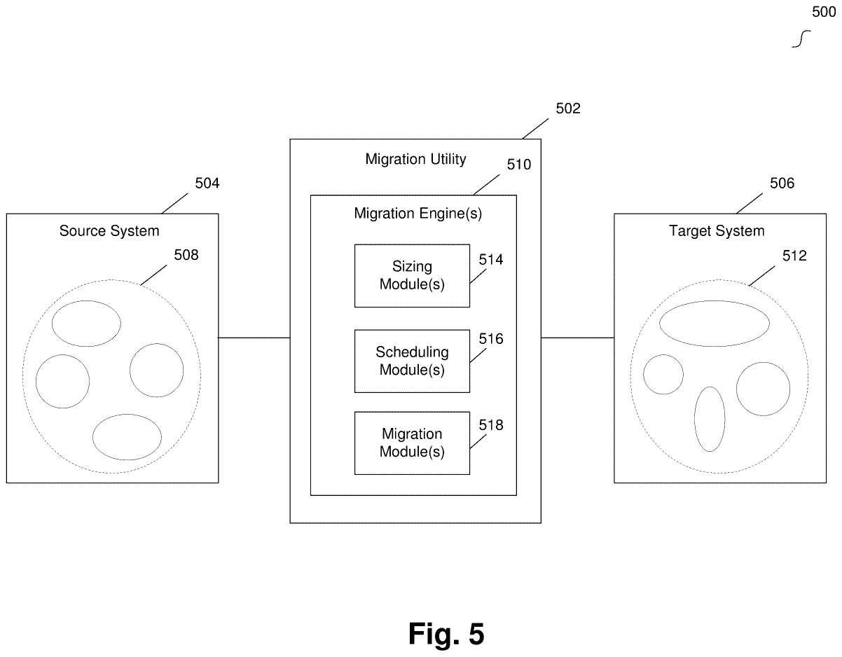

Once the shape of target architecture 312 is determined, the digital elements of source system 304 can be assigned to target service components and/or hardware components. For example, mapping module(s) 416 of FIG. 4 can assign source digital elements to pools of capacity at target architecture 312. Once the source digital elements are mapped to target architecture 312, the digital elements can be migrated from source architecture 308 to target architecture 312. For example, migration module(s) 318 can be similar to migration module(s) 518, which is further described with reference to FIG. 5.

FIG. 4 illustrates a system for migrating digital elements from a source system to a target system using digital element sizing and target system mapping according to an example embodiment. Diagram 400 illustrates migration utility 402, source system 404, target system 406, source architecture 408, migration engine(s) 410, target architecture 412, sizing module(s) 414, mapping module(s) 416, and migration module(s) 418.

Sizing module(s) 414 of FIG. 4 can be similar to sizing module(s) 314 of FIG. 3. For example, sizing module(s) 414 can size digital elements of source architecture 408 and determine resource requirements for the digital elements. Migration utility 402 can also generate a shape for target architecture 412 (e.g., via shape module(s) 318 of FIG. 3), such as a plurality of hardware components and/or service components that comprise various operating characteristics (e.g., processing power, storage, memory, etc.).

Mapping module(s) 416 can map classified digital elements from source architecture 408 to pools of capacity at target architecture 412. For example, mapping module(s) 416 can map classified digital elements to pools of capacity at target architecture 412 based on a consolidation policies.

In some implementations, the classified digital elements of source architecture 408 can comprise parameters, such as data center location, deployment environment (e.g., production, testing), network zone within a data center, service tier (e.g., high-performance, standard), and the like. The virtual machine instances of target architecture 412 can similarly comprise characteristics. Mapping module(s) 416 can assign source digital elements to virtual machine instances of target architecture 412 based on matching the parameters of the source digital elements to the characteristics of the virtual machine instances, such as according to defined mapping rules. In some implementations, at least a portion of the mapping rules can be defined via user input.

In some implementations, consolidation can involve pools of capacity that correspond to hardware components and/or service components of target architecture 412. For example, a pool of capacity can be a portion (or all) of computing resources (e.g., disk space, RAM, processing power, etc.) of a hardware component (e.g., server, device, etc.) or a service component (e.g., logical set of computing resource of a cloud system). Pools of capacity can segment the hardware components and/or service components of target architecture 412 such that different digital elements can be matched to the pools of capacity.

For example, a pool of capacity can comprise parameters. The following are an example set of parameters: data center, environment, and security zone. In this example, parameters values of (‘Chicago, ‘TEST’, ‘PCI’) can represent parameters for a pool of capacity. Chicago can represent the location of the data center, Test can represent the environment (e.g., testing phase), and PCI can represent a security zone (e.g., Payment Card Industry (“PCI”) Data Security Standard). Any other suitable data center locations, application environments (e.g., production, non-production, test, and the like), and security zone (e.g., PCI, non-PCI, and the like) can be implemented.

A consolidation policy can specify how a source digital element (e.g., application, virtual machine, etc.) is mapped to a pool of capacity. For example, a source digital element with parameters values (‘Chicago’, ‘UAT’, ‘PCI’) can be mapped to the above pool of capacity if consolidation rules define that ‘UAT’ is mapped to ‘test’ for digital element consolidation.

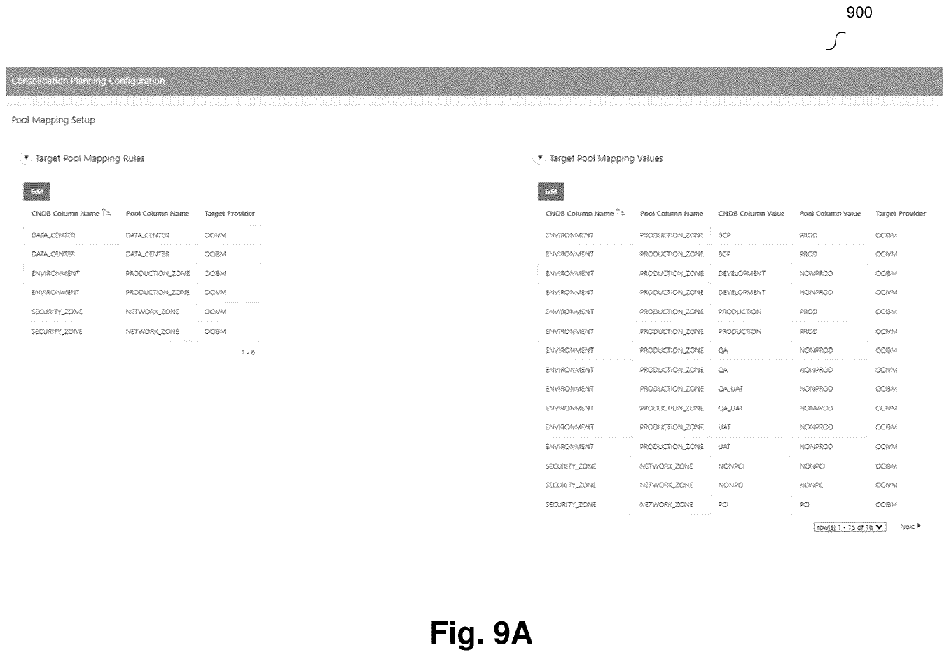

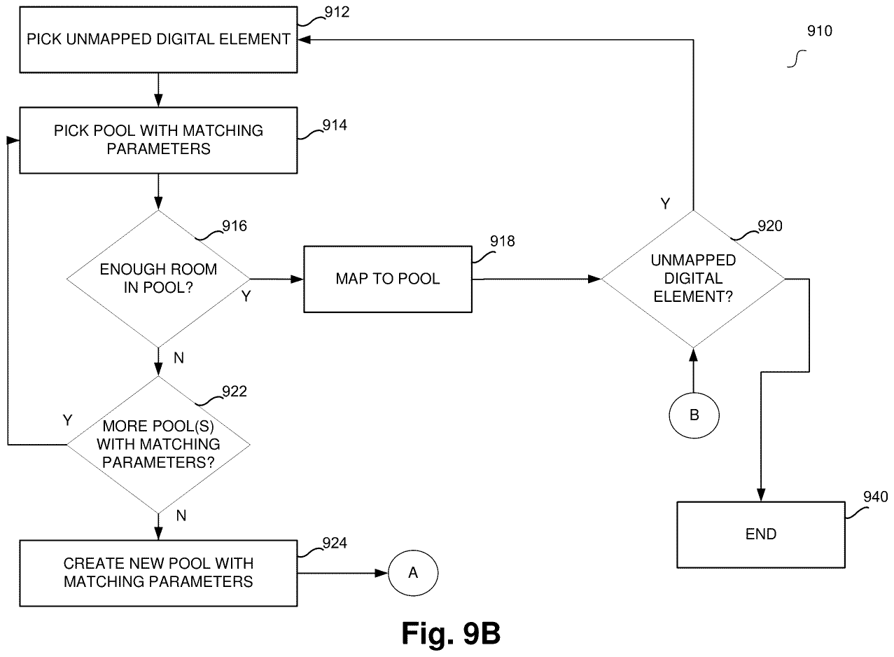

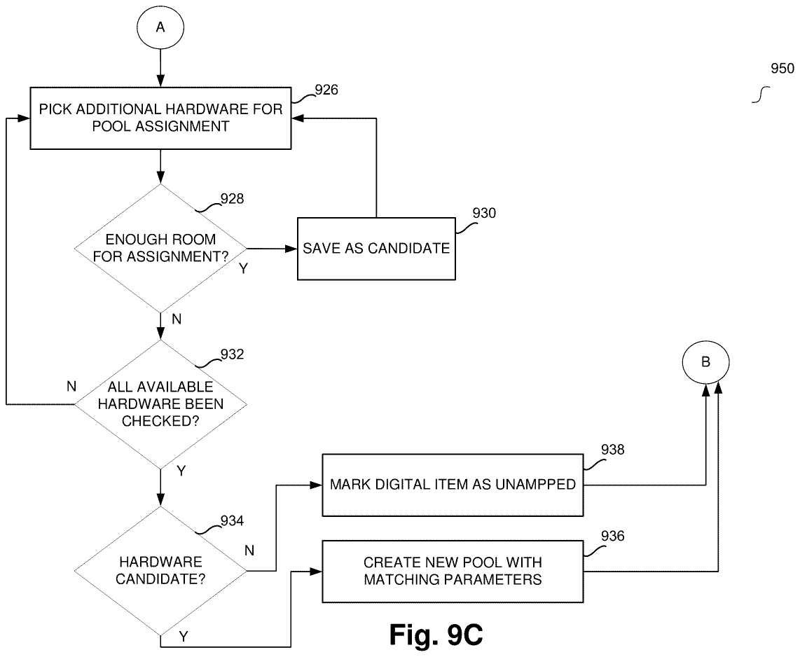

FIG. 9A illustrates a diagram of a user interface for mapping digital element parameters to a target architecture according to an example embodiment. User interface 900A illustrates a user interface for defining rules for mapping digital elements (e.g., source virtual machines and/or source applications) to a target architecture. User interface 900A illustrates rules for matching source digital element parameters to parameters for target hardware and/or service components. For example, user interface 900A can be used to configure the rules for capacity pool mapping. In the illustrated example, user interface 900A displays rules for mapping source digital element (e.g., CNDB) parameter column names and source digital element parameter column values to pool (e.g., pool of capacity) parameter column names and pool parameter column values. This illustrated set of rules can be used to match a source digital element's parameters to a pool of capacity at target architecture 412.

FIGS. 9B and 9C illustrate a flow diagram for consolidating digital elements to pools of capacity at target architecture according to an example embodiment. For example, processes 920 and 950 can be performed to assign digital elements (e.g., source applications, source virtual machines, etc.) to pools of capacity at target architecture 412.

At 912, a new unmapped source digital element, can be selected for mapping. The unmapped source digital elements can comprise source digital element parameters used for mapping source digital elements to target pools of capacity. At 914, a pool of capacity with matching parameters can be selected. For example, as described above, rules can be determined for matching source digital element parameter names/values to pools of capacity parameter names/values. Based on the matching rules defined, a matching pool of capacity can be selected for the unmapped source digital element.

At 916, it is determined whether the selected pool of capacity has enough available resources to map the unmapped source digital element. For example, the pool of capacity can comprise a portion (or all) of a component of target architecture (e.g., target virtual machine instance, such as a computing service component, and/or target server/device, such as a hardware component, etc.). It can be determined whether the selected pool of capacity has enough resources (e.g., processor capacity, RAM, disk space, etc.) to satisfy the requirements of the unmapped source digital element.

For example, source digital elements can be sized by migration utility 302. Example sizing attributes for each source digital element include: disk size, production status, and RAM memory usage. Other suitable sizing attributes that migration utility 302 can determine for digital elements includes: application/VM size (e.g., image of application), size of data tier for application/VM for migration, number of concurrent users (e.g., range), number of affiliated/dependent databases and/or aggregate size of these databases, or any other suitable attributes.

The capacity available at a given pool of capacity can be determined by subtracting the required resources for the source digital elements mapped to the given pool of capacity (e.g., according to the determined sizes of these assigned source digital elements) from the resources allocated to the pool of capacity (e.g., computing resources from target hardware and/or service components allocated to the pool). Implementations can determine whether the available capacity at a given pool of capacity is sufficient to meet the sizing for the unmapped source digital element.

When the selected pool of capacity has enough available resources, the flow can progress to 918, where the unmapped source digital element can be mapped to the pool of capacity. In other words, the hardware component/software component allocated to the pool of capacity can be assigned to host the unmapped source digital element. In some implementations, the source digital element (and its affiliated data tier) can be migrated to the pool of capacity (e.g., associated hardware) at the migration stage such that the pool of capacity hosts a target digital element that correspond to the source digital element.

At 920, it is determined whether any additional unmapped source digital elements are remaining. When unmapped source digital elements are remaining, the flow can proceed back to 912 to select an unmapped source digital element. When no unmapped source digital elements are remaining, the flowchart can terminate at block 940.

At 916, when the selected pool of capacity does not have enough available resources, the flow can progress to 922, where it is determined whether other pools of capacity with matching parameters are available (e.g., existing and available for mapping). When other pools of capacity are available, the flow can progress back to 914, where a next pool of capacity with matching parameters can be selected.

When other pools of capacity are not available, the flowchart can progress to 922, where a new pool of capacity can be created with matching consolidation parameters, and the unmapped source digital element can be mapped to the new pool of capacity. In some implementations, at block 914 no pool of capacity with matching parameters may be found, and in this scenario the flow can progress directly to block 924, where a new pool of capacity can be created.

FIG. 9C illustrates a flow diagram for creating a new pool of capacity when performing consolidation according to an example embodiment. At 926, a hardware component and/or service component from target architecture 412 be selected for the new pool of capacity.

In some implementations, a hardware component and/or service component with parameters that match the unmapped source digital element can be selected. For example, hardware components and/or service components may also comprise hardware parameters similar to the pool parameters for pools of capacity. In these examples, a hardware component and/or service component with parameters that match the unmapped source digital element can be selected. In some implementations, one or more hardware components and/or service components can be assigned parameters to match the parameters of the unmapped source digital element.

At 928, it can be determined whether the selected hardware component and/or service component has enough resources to host the unmapped source digital element. For example, it can be determined whether the hardware component and/or service component has enough computing resources (e.g., available processing capacity, disk space, RAM, etc.) to accommodate a new pool of capacity for the unmapped source digital element.

In some implementations, the computing resources for the new pool of capacity can be based on the sizing of the unmapped source digital element. For example, the pool of capacity can be assigned a) computing resources according to the sizing of the unmapped source digital element, b) computing resources that exceed the sizing of the unmapped source digital element (e.g., 20% larger, 50% larger, 100% larger, etc.), c) a default level of computing resources, d) or any other suitable level of computing resources.

When the hardware component and/or service component has enough available resources for the new pool of capacity, the flow can progress to 930, where the selected hardware component and/or service component can be saved as a candidate for the new pool of capacity. The flow can then progress back to 926, where a next hardware component and/or service component with matching attributes can be selected. When the selected hardware component and/or service component does not have enough available resources, the flow can progress to 932, where it can be determined whether there are additional hardware components and/or service components to be checked. When there are additional hardware components and/or service components, the flow can progress back to 926, where a next hardware component and/or service component can be selected.

At 926-932, a list of candidate hardware components and/or service components can be generated. When there are no additional hardware components and/or service components to be checked, the flow can progress to 934, where it is determined whether a hardware component and/or service component with enough resources is available for the pool of capacity. When there is a hardware component and/or service component with enough resources (e.g., at least one candidate is stored), the flow can progress to 936, where the new pool of capacity is assigned to one of the candidate hardware components and/or service components.

One or more selection policies can be used to select the hardware component and/or service component from the candidates for the new pool of capacity. For example, one or more source digital elements may comprise a priority, and the hardware component and/or service component can be selected according to the priority. Example priorities can include a numeric value, relative values (e.g., low, medium, high), or any other suitable priorities. In some implementations, hardware components and/or service components can comprise a quality metric. For example, hardware components with greater computing resources (e.g., disk space, RAM, processing power, etc.) can comprise a larger quality metric than hardware components with fewer computing resources. Similarly, service components with greater computing resources can comprise a larger quality metric than service components with fewer computing resources.

In some implementations, the hardware component and/or service component from the candidates can be selected according to the priority level for the unmatched source digital element. For example, hardware components and/or service components with high quality metrics can be selected for high priority source digital elements and hardware components and/or service components with low quality metrics can be selected for low priority source digital elements.

In another example, hardware component and/or service component from the candidates can be selected based on a sizing for the pool of capacity. A size metric can be calculated using the attributes for the pool of capacity (e.g., disk space, processing power, RAM, etc.), and a hardware component and/or service component from the candidates can be selected that matches the size metric. In this example, each of the components in the list of candidates can comprise enough resources to accommodate the new pool of capacity. The available resources (e.g., total resources minus resources assigned to other pools of capacity and/or source digital elements) for each hardware component and/or service component from the candidates can be used to calculate an availability metric for the components. In some implementations, the hardware component and/or service component with a largest availability metric can be selected for the pool of capacity. In another example, the hardware component and/or service component with an availability that matches closest to the size metric for the pool of capacity can be selected for the pool of capacity. Any other suitable selection policy can be implemented to select the hardware component and/or service component from the candidates for the new pool of capacity.

Once the new pool of capacity is assigned to hardware, the unmapped source digital element can be mapped to the newly created pool of capacity. The flow can then progress back to 920, where it can be determined whether there are additional unmapped source databases, as described above.

When there is no hardware component and/or service component with enough resources (e.g., no candidates are stored), the flow can progress to 938, where it is determined that the unmapped source digital element cannot be mapped to the target platform, as selected. The unmapped source digital element can then be marked, and can be reported to embodiments of the software tool as an unmapped digital element. The flow can then progress back to 910, where it can be determined whether there are additional unmapped source digital elements, as described above.

In some implementations, the consolidation flow can be part of a project impact analysis and/or target resource projection, as previously disclosed. For example, any unmapped source digital elements can be reported as part of a project impact analysis. In addition, new hardware components and/or service components can be determined for any unmapped source digital elements using a target resource projection.

For example, the flow for determining new hardware components and/or service components for the unmapped digital element can be similar to the consolidation flow. In particular, target resource projection includes selecting a target platform and consolidation strategy, as previously disclosed. Embodiments can take all unmapped digital elements, consolidate them to instances of hardware components and/or service components (the same or similar to the way the mapped digital elements are consolidated in FIGS. 9B-9C), and report any utilized hardware components and/or service components (e.g., components with new mappings) as the projected component need.

In some implementations, mapping module(s) 416 generates multiple variations of mapping scenarios that map source digital elements to virtual machine instances of target architecture 412. For example, consolidation policies can define rule sets and/or policies for mapping source digital elements to target hardware components and/or service components. Mapping module(s) 416 can vary the consolidation policies to generate the multiple variations of mapping scenarios. For example, consolidation policy variations can include varying: a) the rules for matching digital element parameters to pools of capacity, b) an order in which to select digital elements for mapping, c) policies for generating a new pool of capacity (e.g., sizing for the new pool of capacity, etc.), d) policies for selecting hardware components and/or service components from a list of candidates for a new pool of capacity, and the like. Because the variations in consolidation policies changes the way digital elements are mapped to pools of capacity and/or how pools of capacity are assigned to hardware components and/or service components, the variations in consolidation policies results in multiple variations of mapping scenarios.

In some implementations, the multiple mapping scenarios can be analyzed to generate consolidation summaries. For example, each consolidation summary can include a utilization metric of the target architecture for the corresponding mapping scenario and/or one or more source digital elements that remain unmapped in the corresponding mapping scenario. Mapping scenarios with few or no unmapped source digital elements and high target architecture utilization metrics (e.g., percentage of target architecture utilized by mapped source digital elements) can be viewed as efficient and effective consolidation scenarios.

In some implementations, a mapping that consolidates source digital elements to the virtual machine instances of target architecture 412 can be selected from the mapping scenarios. The mapping scenario can be selected according to a) a user selection of the one mapping scenario from the plurality of mapping scenarios, or b) a ranking of the utilization metrics of the target architectures for the mapping scenarios. Once the source digital elements are assigned to pools of capacity of target architecture 412 via the selected mapping, the digital elements can be migrated from source architecture 408 to target architecture 412. For example, migration module(s) 418 can be similar to migration module(s) 518, which is further described with reference to FIG. 5.

FIG. 5 illustrates a system for migrating digital elements from a source system to a target system using a migration schedule according to an example embodiment. Diagram 500 illustrates migration utility 502, source system 504, target system 506, source architecture 508, migration engine(s) 510, target architecture 512, sizing module(s) 514, scheduling module(s) 516, and migration module(s) 518.

Sizing module(s) 514 of FIG. 4 can be similar to sizing module(s) 314 of FIG. 3. For example, sizing module(s) 414 can sizing module(s) 514 can size digital elements of source architecture 508 and determine resource requirements for the digital elements. Migration utility 402 can also generate a shape for target architecture 412 (e.g., via shape module(s) 318 of FIG. 3), such as a plurality of hardware components and/or service components that comprise various operating characteristics (e.g., processing power, storage, memory, etc.). Migration utility 502 can also generate a shape for target architecture 512 (e.g., via shape module(s) 318 of FIG. 3), such as a plurality of hardware components and/or service components that comprise various operating characteristics (e.g., processing power, storage, memory, etc.) and map the source digital elements to pools of capacity at target architecture 512 (e.g., via mapping module(s) 416 of FIG. 4).

Scheduling module(s) 516 can generate a migration schedule for migrating the source digital elements, from source architecture 508, to their mapped pool of capacity (e.g., hardware component and/or service component that hosts the mapped pool of capacity) at target architecture 512. For example, scheduling module(s) 516 can apply scheduling rules and build a schedule for the source digital elements. In some implementations, the schedule can comprise a number of time periods (e.g., days, weeks, months, etc.) and digital elements can be assigned to particular time periods. The digital elements can each be associated with a scheduling weight, such as based on its predefined migration complexity classification, and the scheduling weights can be used to assign the digital elements to the periods of time.

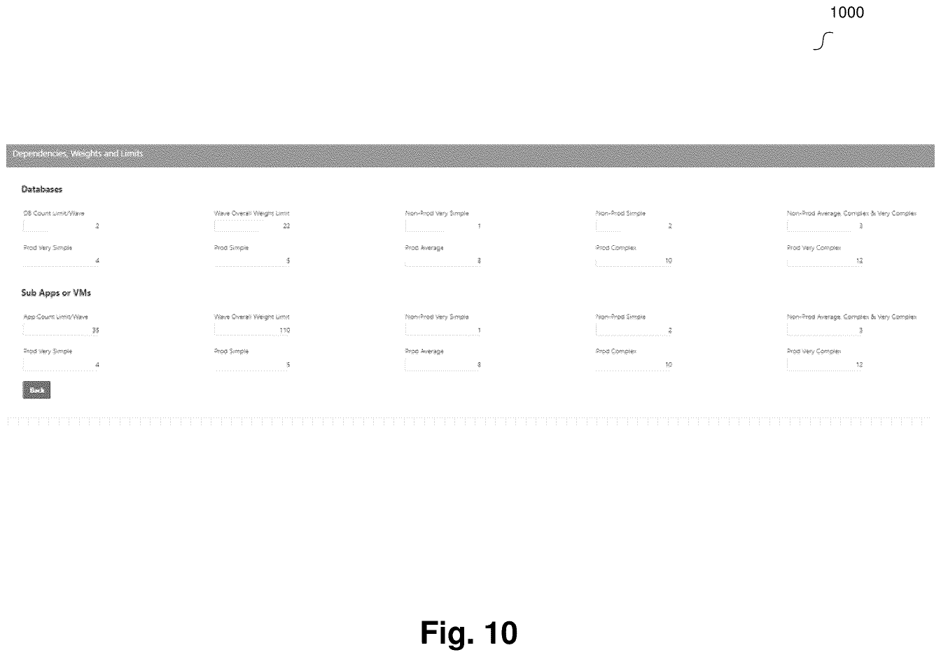

In some implementations, at least a portion of the scheduling weights that correspond to predefined classifications can be input by a user. FIG. 10 illustrates a diagram of a user interface for assigning values for a migration scheduling workflow according to an example embodiment. Diagram 1000 illustrates a user interface for defining scheduling parameters for migrating digital elements (e.g., source virtual machines and/or source applications) to a target architecture, such as defining the migration weights of digital element classifications.

Scheduling module(s) 516 can then assign digital elements to periods of time according to migration rules. Example migration rules include: scheduling of certain life cycle environments on certain days of the week, such a non-prod during the week and prod on the weekend; threshold weight for periods of time; threshold number of digital element migrations for periods of time; blackout dates; restrictions on migrating certain digital elements as a group, for example due to dependency relationships; and the like. For example, scheduling module(s) 516 can enforce the weight threshold for a given period of time by ensuring that the aggregate scheduling weights of the digital elements assigned to given period of time does not exceed the weight threshold. In another example, scheduling module(s) 516 can enforce the threshold number of migrations for a given period of time by ensuring that the number of digital elements assigned to the given period of time does not exceed the number of migrations threshold.

Scheduling module(s) 516 can categorize different environments into logical groups, such as development, testing, staging, and production, which can support efficiently managing dependencies and facilitating coordinated migrations. In some implementations, a scheduling dependencies algorithm can establish relationships between source digital elements and dependent databases based on business contingency process (“BCP”) dependencies, application dependencies, and/or replication dependencies.

In some implementations, application and replication dependencies can be determined. For example, application and replication dependencies can be defined by a user marking dependencies using a user interface (e.g., GUI). In some implementations, a unique number can be assigned to databases with dependencies to applications and/or virtual machines. In this example, digital elements and databases with a same application dependency number stored can be dependent on each other.

In some implementations, digital elements that have dependencies to one another can also include provisioning and/or migration priority levels that are equal (or that are adjusted to be equal) so that they can be migrated with or next to each other (e.g., according to a generated schedule). For example, when applications and/or virtual machines with different priorities are marked as dependent, the highest priority amongst them can be used such that the application and/or virtual machine with the lower priority is elevated to the higher priority.

In some implementations, using default or custom rules, a scheduling prioritization algorithm evaluates the overall migration estate and prioritizes resources to provision and/or migrate. Priorities for digital elements can be defined, for example, using values from the loaded detailed questionnaire (e.g., the migration group). Adjustments can be automatically performed based on the provided (or based on updated) priorities.

In some implementations, digital elements within a priority group can be arranged alphabetically, or based on some other value or metric. A priority number can be generated for each request where the lowest number is the first priority for completion and the highest number is the last to be completed. Overall groupings within a specific application can be illustrated by the following example:

### Application

Entire Application's Set of Databases
   Sub-Group A Environments
      Sub-Group B Environments
         Sub-Group C Environments
Repeat for each application of Group 1 until application list is exhausted.

In some implementations, using default or custom rules, resources for creation and/or migration can be scheduled by date and time using a calculated rate of migration (e.g., workload level). For example, a weekly workload can be represented by a weighted value assigned to request (e.g., migration task) and maximum weights allowed for that period of time (e.g., week). The weight definitions can be defined by default or custom rules. If the workload (weight) of a week is exceeded, the request work (e.g., migration task) can be pushed into the next week; and on and on until there are no more requests to complete. Examples rules include: ensure maximum weighted value for a wave (week's) workload does not exceed thresholds; and ensure maximum quantity of provisioning or migrations does not exceed thresholds.

In some implementations, using a prioritization algorithm and configuration details defined above, source digital elements and/or databases can be fed into a time frame (e.g., weekly time frame) as follows:
1. Example default schedule rules (or customized rules) can be defined as follows for digital element and/or dependent database migrations:

| Migration Type | Migration Weight | |
|---|---|---|
| Non-Production | Very Simple | 1 |
| | Simple | |
| Non-Production | Average | 3 |
| | Complex | |
| | Very Complex | |
| Production | Very Simple | 4 |
| Production | Simple | 5 |
| Production | Average | 8 |
| Production | Complex | 10 |
| Production | Very Complex | 12 |

| Weekly Workload | |
|---|---|
| Rule | Value |
| Maximum Workload | 110 |
| Weight Allowed | |
| Maximum # of | 35 |
| Migrations Allowed | |

2. Week X has no digital elements and/or dependent database migrations assigned (e.g., weekly workload weight=0).
3. Loop
   a. Take the next prioritized migration candidate for Week X workload.
   b. Add the workload weight of migration candidate based on the Migration Type (listed in above table) to the week X's total workload weight.
   c. Does the week X workload exceed the defined maximum?
   d. Does the week X workload exceed the maximum quantity of migrations?
   e. If no to any of the above two questions then add the migration to week X's workload.
   f. If yes to any of the above two questions then do not add migration to week X's workload. Proceed to week X+1 and enter this loop again for Week X+1
4. Stop when all digital elements and/or dependent database migrations have been assigned to a week.

Migration module(s) 518 can then migrate each source digital element from source architecture 508 to its mapped virtual machine instances, of target architecture 512, on its assigned period of time. For example, application, virtual machines, and/or dependent database data can be migrated from source system 504 to target system 506. Migration module(s) 518 can initially provision virtual machine instances of target architecture 512, such as configure the virtual machine instances to receive and operate the digital elements of source architecture 508. In some implementations, the hardware component and/or service component that hosts a given source digital element can be provisioned prior to migration of the given source digital element. For example, a virtual machine instance can be provisioned such that the virtual machine instance can operate the digital element being migrated.

In some implementations, migration module(s) 518 can generate a digital snapshot of a given digital element (e.g., a copy of digital element's data in its current state) and restore the snapshot at the virtual machine instance mapped to the given digital element. Migration module(s) 518 can also synchronize the copy of the digital element restored from the digital snapshot at target architecture 512 with the original version of the digital element at source architecture 508 to complete the migration. For example, migration module(s) 518 can utilize one or more migration services (e.g., RackWare, etc.) to implement the migration. In some implementations, defined workflows (e.g., defined via a dynamic process manager) can be utilized to implement custom configurations (e.g., application-specific and/or virtual machine-specific) to ensure reliable execution of migrated digital elements. Migration module(s) 518 can migrate the digital elements in any other suitable manner.

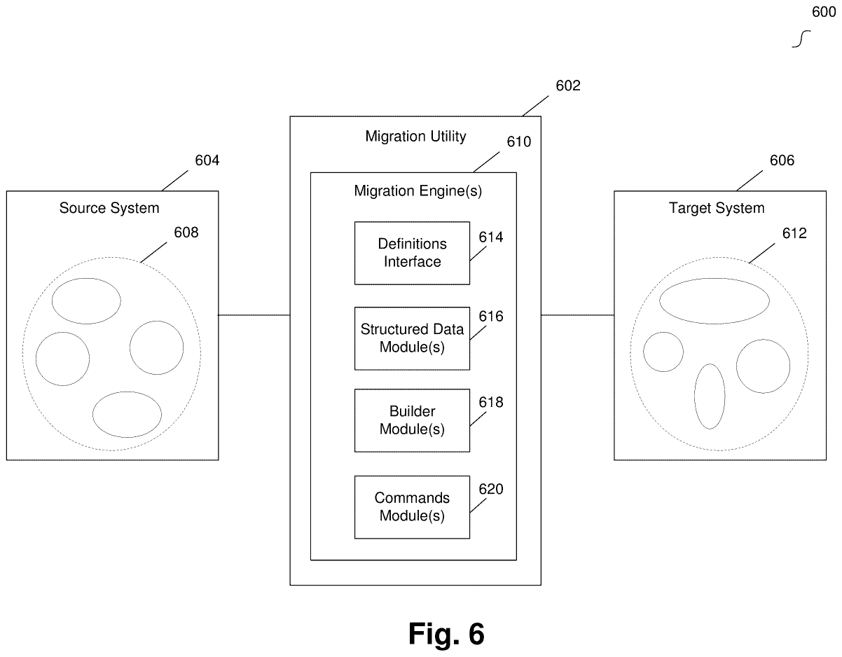

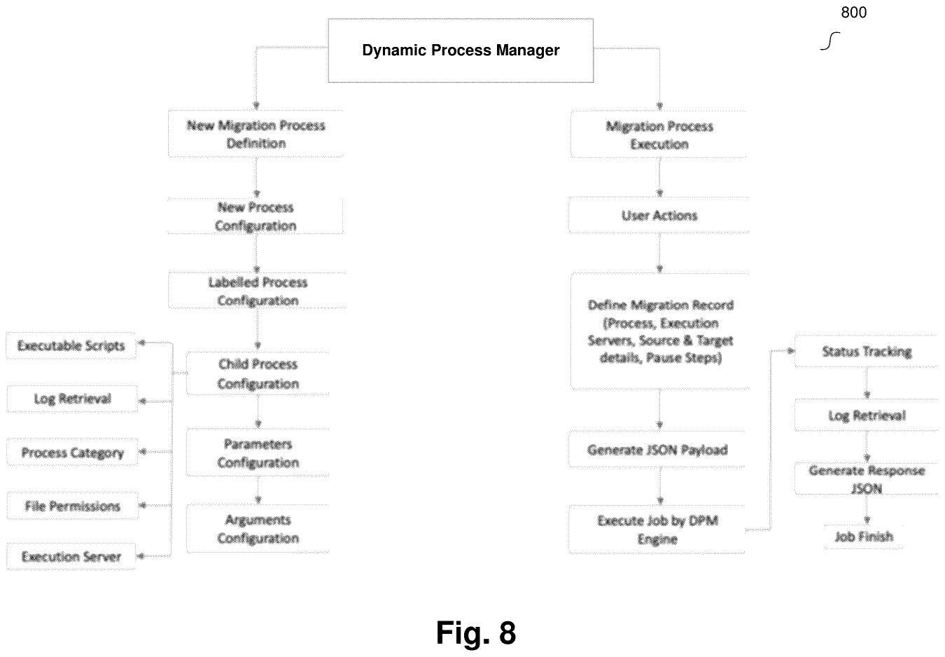

FIG. 6 illustrates a system for migrating digital elements from a source system to a target system using generated commands according to an example embodiment. Diagram 600 illustrates migration utility 602, source system 604, target system 606, source architecture 608, migration engine(s) 610, target architecture 612, definitions interface 614, structured data module(s) 616, builder module(s) 618, and commands module(s) 620. For example, migrating digital elements from source architecture 608 to target architecture 612, such as according to a generated migration schedule and selected mapping, can include implementing migration workflow(s) defined via definition(s) interface 614. In some implementations, the component of migration utility 602 can implement a dynamic process manager (DPM), which is further described with reference to FIG. 8.

Definition(s) interface 614 can receive, for a given new migration workflow, a number of definitions including: a label for the migration workflow; labels for sub-components of the migration workflow, parameters that correspond to each of the sub-components, resource locators that corresponds to one or more scripts for the sub-components, and a predefined order for at least a portion of the sub-components. In some implementations, definition(s) interface 614 can receive these definitions via an online form (e.g., from a user), an application programming interface (API) call, or via any other suitable manner.

Structured data module(s) 616 can then generate a structured data representation from the workflow definitions received via definition(s) interface 614. The generated structured data representation of the received definitions can be a JavaScript Object Notation (JSON) file, a markup language data file, a data file that organizes the sub-components according to tags, or a data file that organizes the sub-components according to name-value relationships, arrays, or serializable data values. For example, the workflow definitions can correspond to entities and values in the structured data representation.

Below is an example JSON structured data filed generated for provided workflow definitions(s) that comprises various entities and values, such as migration request ID, job ID, labeled migration workflow name, and the like:

```
      {
        “requestId” : 1,
        “jobId”: 1,
        “processName”: “dpump”,
        “workingDirectory”: “<NAS working directory>”,
        “labeledProcessName”:“dpump”,
        “processConfig”:[
        {
          “processName” : “infraSetup”,
          “run” : “Y”,
          “require” : “infraSetup”,
          “processCategory” : “M360”,
          “adjustPermissionsofWorkingDirectory” : “Y”,
          “logRetrievalScripts” : “”,
          “mode” : “sync”
        },
        {
          “processName” : “dpumpSource”,
          “parentProcessName” : “”,
          “executionServer” : “sourceConnection”,
          “script” : “nohup ./run_DPUMP_src.sh [sourceDatabaseSid]
[preMigrationCheckOnly] [sourceDatabaseName] & ”,
          “childProcesses” :
          [
          ],
          “run” : “Y”,
          “processCategory” : “M360”,
          “adjustPermissionsofWorkingDirectory” : “Y”,
          “logRetrievalScripts” : “file.zip, migscripts/process/dpump_source.log”,
          “mode” : “async”
        },
        {
          “processName” : “dpumpTarget”,
          “parentProcessName” : “”,
          “executionServer” : “targetConnection”,
          “script” : “nohup ./run_DPUMP_tgt.sh [targetDatabaseSid]
[preMigrationCheckOnly] [targetDatabaseName] [targetProvider] & ”,
          “childProcesses” :
          [
          ],
          “run” : “Y”,
          “processCategory” : “M360”,
          “adjustPermissionsofWorkingDirectory” : “Y”,
          “logRetrievalScripts” : “file.zip, migscripts/process/dpump_target.log”,
          “mode” : “async”
        }
        ],
        “parametersConfig”:[
        {
          “paramName” : “sourceDatabaseSid”,
          “paramKey” : “sourceDatabaseSid”,
          “paramValue” : “SOURCE_DB_SID”,
          “isPartOfParameterFile” : “Y”,
          “isPartOfResponseFile” : “N”,
          “isUserDefined” : “N”,
          “gatewayParamName” : “sourceDatabaseSid”
        },
        {
          “paramName” : “targetDatabaseSid”,
          “paramKey” : “targetDatabaseSid”,
          “paramValue” : “TARGET_DB_SID”,
          “isPartOfParameterFile” : “Y”
          “isPartOfResponseFile” : “N”,
          “isUserDefined” : “N”,
          “gatewayParamName” : “targetDatabaseSid”
        }
        ]
          “sourceConnection” :
          {
          “user” : “opc”,
          “password” : “”,
          “sudoUser” : “oracle”,
          “sudoStrategy” : “sudo”,
          “host” : “10.20.16.108”,
          “port” : 22,
          “key” : “XXXXXXXXXXXXXXXXXXXXXXXXXXXXXX”
          },
      “targetConnection” :
          {
          “user” : “opc”,
          “password” : “”,
          “sudoUser” : “oracle”,
          “sudoStrategy” : “sudo”,
          “host” : “10.20.16.209”,
          “port” : 22,
          “key” : “XXXXXXXXXXXXXXXXXXXXXXXXXXXXXX”
        },
        “source TransferConnection” :
        {
          “user” : “opc”,
          “password” : “”,
          “sudoUser” : “oracle”,
          “sudoStrategy” : “sudo”,
          “host” : “10.20.14.210”,
          “port” : 22,
          “key” : “XXXXXXXXXXXXXXXXXXXXXXXXXXXXXX”
        },
      “targetTransferConnection” :
        {
          “user” : “”,
          “password” : “”,
          “sudoUser” : “”,
          “sudoStrategy” : “”,
          “host” : “”,
          “port” : 0,
          “key” : “”
        },
        “connectionRoute”:{
        }
      }
```

Builder module(s) 618 can build, using the structured data representation, a set of commands for performing the defined migration workflow. For example, builder module(s) 618 can include a parser (e.g., JSON parser, etc.) that can parse the structured data representation and extract aspects of the defined migration workflow (e.g., entities and values). Builder module(s) 618 can also include a sequencer that structures commands for performing the workflow (e.g., script resource for each sub-component defined via the structured data representation) using parameters for the commands (e.g., parameters for each script resource defined via the structured data representation) and sequences the commands (e.g., using an ordered defined via the structured data representation).

Commands module(s) 620 can then execute the set of commands built via builder module(s) 618. For example, the migration commands (e.g., script commands) can be executed using any parameters for the migration commands in the order sequenced by builder module(s) 618. During execution, commands module(s) 620 can pull results for each executed command, containing information such as status, message codes, errors/error messages, logs, etc., and generate a structured data representation that represents the status and/or results of the execution. Below is an example JSON response generated based on execution triggered via the above JSON payload:

```
{
  “error”: false,
  “message”: “Got Migration Status”,
  “data”: {
    “status”: “Completed”,
    “statuses”: {
      “initial”: 0,
      “started”: 0,
      “failed”: 15,
      “complete”: 22
    },
    “results”: {
      “dynamicProcessinfraSetupproduceKeys”: {
        “error”: false,
        “message”: {
          “code”: 0,
          “codeRaisedFromFile”: “”,
          “errorCodeMessage”: “”,
          “extraFields”: null,
          “output”: “Produced keys perfectly”
        },
        “startTime”: 1712323662195,
        “endTime”: 1712323662236
      },
      “dynamicProcessinfraSetupsetupproduceAdvancedParametersFiles”: {
        “error”: false,
        “message”: {
          “code”: 0,
          “codeRaisedFromFile”: “”,
          “errorCodeMessage”: “”,
          “extraFields”: null,
          “output”: “”
        },
        “startTime”: 1712323662236,
        “endTime”: 1712323662262
      }
    },
    “startTime”: 1712323662028,
    “endTime”: 1712323739909
  }
}
```

The executed set of commands can comprise a migration workflow that migrates digital elements from source architecture 608 to target architecture 612, a configuration workflow that configures migrated digital elements, and the like. In some implementations, the migration workflow can be executed as part of a migration schedule and migration plan, where a given digital element is migrated from source architecture 608 at an assigned period of time to an assigned virtual machine instance at target architecture 612 via execution of the set of commands. In some implementations, after a digital element is migrated to a virtual machine instance at target architecture 612 (e.g., according to a migration schedule), the executed set of commands can configure the digital element to operate in its new environment (e.g., configure an application to interact with dependent databases, configure applications to interact with one another, configure network settings, etc.).

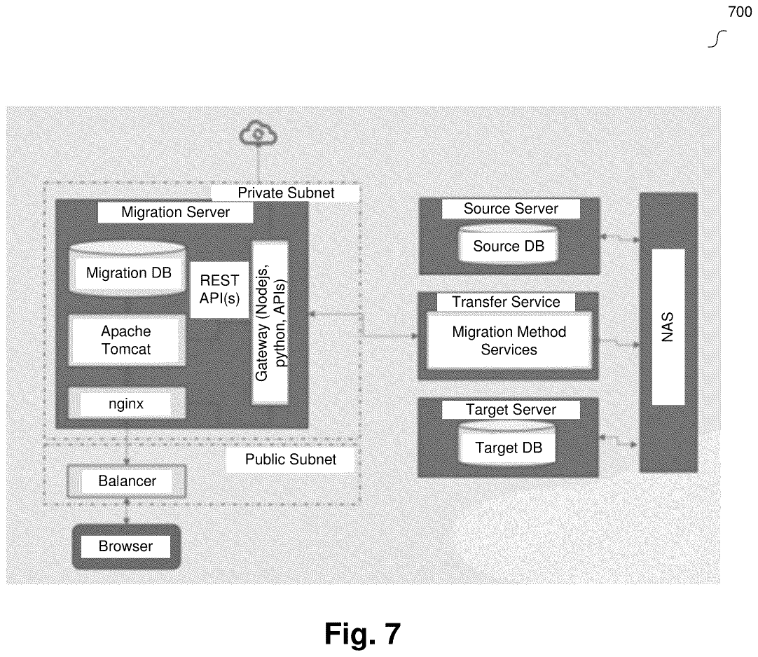

FIG. 7 illustrates system components for migrating digital elements via a migration server according to an example embodiment. Diagram 700 illustrates computing components for migrating source digital element(s) (e.g., source virtual machines and/or source applications) from a source architecture to a target architecture. In some implementations, migration workflow(s) of this disclosure can be implemented via system components of diagram 700. For example, components of the illustrated migration server and/or transfer service can implement the functionality of the migration utility and/or dynamic process manager.

FIG. 8 illustrates a flow diagram of a dynamic process manager according to an example embodiment. Diagram 800 illustrates a flow diagram for defining dynamic process(es) for migrating digital elements (e.g., source virtual machines and/or source applications). In some implementations, the functionality of diagram 800 can be performed via system components of diagram 600 of FIG. 6 and/or system components of diagram 700 of FIG. 7.

The dynamic process manager (DPM) can comprise multiple components. Example components of the DPM, such as components of a gateway engine, include:
JSON parser—accepts input as Request JSON, parses each component of this JSON and extracts different entities and values which can be further referred by other modules. JSON parser ensures compatibility and ease of data exchange.
Process Sequencer—DPM reviews the input payload and check for executable processes and filters them and put those in to correct sequence order for further execution.
Job Executor—DPM will then start executing the migration scripts in the sequence defined through the Process Sequencer.
Job Retriever—This will retrieve the status of each Job, resulting into status, message codes, errors/error messages, logs, etc.
Process Categories: [COPY, RUN, PASS]—DPM can execute any kind of Linux command for the migration script under execution such as copy operation, run operation, or pass operation.
Log Aggregator—It retrieves logs as specified in the log retrieval scripts column
Response JSON Constructor—DPM will proceed with execution by generating a Response JSON which can be further consumed by database and GUI operations to report results back to the users. That will comprise information such as status, message codes, errors/error messages, logs, operation executed brief, summary of jobs executed, etc.

The DPM supports an extensible framework for migration workflows. For example, new workflow definitions can be added and the DPM can implement these new workflow definitions to perform new migration workflows. A first portion of diagram 800 illustrates a workflow for defining a new migration process. For example, the following functionality can be used to define a new migration process:
Create a new labelled process
Define child processes comprising the following information
   Process name: Specify a label for child process e.g. “dpumpSource”
   Parent Process Name: Specify name of child process which is parent to current process
   Execution Server: Specify any execution server among source, source transfer, target, target transfer server
   Script: Specify any executable command which can run on specified execution server above
   Process Category: child processes can be categorized among different categories, such as m360, zdm, rackware, etc.
   Adjust Permission on Working Directory Flag: This can be yes or no, this you can decide based on the program logic, if next child process is going to consume files produced by the current child process, then specify yes. This setting will trigger the related permission to be set for files.
   Log Retrieval Script: Specify output logfiles which can be retrieved post execution of child process
   Mode: This can be sync/async. A sync child process waits until current job is fully finished before system start execution of the next child process. A async child process will not wait until current job is finished, so this starts next job immediately.
Define Parameters and Arguments

The DPM can store definitions for new migration processes in a config table, such as:

| Labeled | Child | | | | | | Log | |
|---|---|---|---|---|---|---|---|---|
| Process | Process | Execution | | | Exe. | Exe. | Retrieval | Run |
| Name | Name | Flag | Customizable | Order | Server | Script | Script | Mode |
| dpump | infrastructureSetup | Checked | Yes | 1 | Transfer | | | sync |
| dpump | dpumpSource | Checked | Yes | 1 | Source | | | async |
| dpump | dpumpTransfer | Checked | Yes | 2 | Transfer | | | async |
| dpump | dpumpTarget | Checked | Yes | 3 | Target | | | async |

In some implementations, the config table can correspond to a parameters and arguments config table, which stores list of parameters and arguments. An example parameters and arguments config table is below:

| | | Default | Arg. or | |
|---|---|---|---|---|
| Name | Parameter Name | Value | Param | Help text |
| dpump | TARGET_TS_ | SOURCE | Param. | Parameter to |
| | BLOCK_SIZE | | | control what |
| | | | | block size will |
| | | | | be assigned to |
| | | | | tablespaces in target |
| | | | | DB.(DEFAULT |
| | | | | VALUE = |
| | | | | SOURCE). |
| | | | | Possible values: |
| | | | | SOURCE \| TARGET |
| dpump | TARGET_DB_ | 8192 | Param. | Target database |
| | BLOCK_SIZE | | | block size |
| | | | | (DEFAULT |
| | | | | VALUE = 8192) |
| dpump | SOURCE_ | CURRENT_ | Param. | Flashback SCN |
| | FLASHBACK_ | SCN | | can be either |
| | SCN | | | CURRENT_SCN or |
| | | | | a pre-determined |
| | | | | SCN for flashback |
| | | | | (DEFAULT |
| | | | | VALUE = |
| | | | | CURRENT_SCN) |
| dpump | SOURCE_ | 4 | Param. | Degree of |
| | DPUMP_ | | | parallelism for |
| | PARALLELISM | | | source export |
| | | | | (DEFAULT |
| | | | | VALUE = 4) |
| dpump | SOURCE_DB_ | 12 | Param. | Source database |
| | VERSION | | | version with |
| | | | | 2 digits only |
| | | | | (DEFAULT |
| | | | | VALUE = 12) |
| dpump | TARGET_DB_ | 19 | Param. | Target database |
| | VERSION | | | version with |
| | | | | 2 digits only |
| | | | | (DEFAULT |
| | | | | VALUE = 19) |
| dpump | TDE_ | AES128 | Param. | Encryption |
| | ENCRYPTION_ | | | algorithm used to |
| | TYPE | | | create tablespaces |
| | | | | on the target |
| | | | | database (DEFAULT |
| | | | | VALUE = AES128) |

Once a new migration process is defined, the new migration process can be triggered, such as via a user interface or any other suitable trigger. A second portion of diagram 800 illustrates a workflow for executing a defined migration process. Triggering execution via a user interface can involve the following functionality:
User selects a migration approach/migration labelled process for execution
User defines or validates migration record information as follows
   Child process configuration,
   Labelled process parameter values,
   Labelled process argument values,
   Child process pause points
User submits labelled process for execution
User interface software submits an execution job to the dynamic process manager (DPM) and polls execution results at defined frequency
User interface software (or any other suitable component of the DPM) can request generation of a structured data representation (e.g., JSON) of the defined new migration process

The DPM can then execute the requested new migration process. For example, a PL/SQL program (or any other suitable software) can be triggered in response to a new DPM job submission. This triggered program/software can take inputs such as migration record ID, read definitions for the new migration process (e.g., from config table(s), parameters table(s), user inputs), and request generation of the structured data representation (e.g., JSON). The following represents example functionality for DPM execution of a triggered new migration process:
Execution of Request JSON by Gateway Engine
   Accepts input as Request JSON, parses each component of this JSON and extracts different entities and values
   Reviews the input payload and check for executable processes and filter's them and put those in sequence order for further execution
   Executes the migration scripts in the sequence
   Upon execution it pulls result of each job, containing information such as status, message codes, errors/error messages, logs, etc.
   Generates Response JSON
UI software polls the real-time results of a DPM execution job
As soon as job is finished, status and logs are displayed on user interface

Embodiments of the DPM can support improved flexibility and extensibility for digital element migration (e.g., application and/or virtual machine migration). For example, migration of applications and/or virtual machines can involve application-specific and/or virtual machine-specific workflows to ensure reliable execution at a target architecture. Implementations of the DPM support an intuitive and efficient mechanism to add custom workflows such that migrated applications and/or virtual machines can effectively execute at a target architecture.

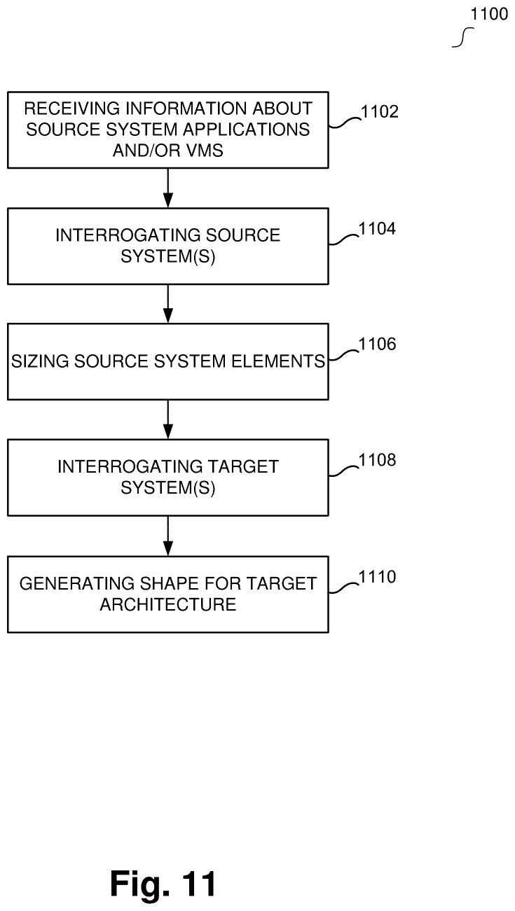

FIG. 11 illustrates a flow diagram performing digital migration of applications and/or virtual machines using source sizing and target shaping according to an example embodiment. In some embodiments, the functionality of FIGS. 11-14 is implemented by software stored in memory or other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software.

At block 1102, process 1100 can receive information about a plurality of source digital elements from a source system. Example source digital elements include applications and/or virtual machines. In some implementations, the received information can include source architecture types for the source digital elements (e.g., type of virtual environment/virtual machine), processor utilization for the source digital elements, memory utilization for the source digital elements, digital element disk size, target cut-over time, or any other suitable information.

At block 1104, process 1100 can interrogate source system(s) to derive information about the plurality of source digital elements. For example, the derived information can include at least a processor utilization per source digital element, memory utilization per source digital element, disk space per source digital element, and the like. The source system(s) can be interrogated via interrogation scripts and/or a manager tool that manages environments for the source digital elements.

At block 1106, process 1100 can size each of the plurality of source digital elements. For example, the source digital elements can be sized according to the processor utilization and memory utilization for the source digital elements to determine resource requirements at a target system. In some implementations, the determined resource requirements for the sized source digital elements define a memory size range and processor utilization range for each source digital element.

At block 1108, process 1100 can interrogate target system(s). For example, some target systems may operate virtual machine instances (e.g., hardware components and/or service components) prior to migration, such as on-premise systems, systems that operate via a third-party, or any other suitable systems. The derived information from the interrogating can include at least a processor capacity for virtual machine instances, memory capacity for virtual machine instances, and the like. The target system(s) can be interrogated via interrogation scripts and/or a manager tool that manages environments for the target virtual machine instances.

At block 1110, process 1100 can generate a shape for a target architecture based on the resource requirements for the source digital elements and/or interrogated target system virtual machine instances. For example, the shape can be a plurality of target virtual machine instances implemented by target hardware components and/or target service components of the target architecture. In some implementations, the target architecture is configured to receive migration of the source digital elements and operate target digital elements, via the target virtual machine instances, corresponding to the source digital elements.

In some implementations, the target hardware components of the target architecture correspond to hardware devices comprising hardware attributes and the target service components of the target architecture correspond to logical computing services comprising service attributes. For example, the hardware attributes can be computing resources of the corresponding hardware device, such as physical processor capacity, physical disk space, and physical RAM capacity. In another example, the service attributes can be cloud computing resources from a cloud service provider, such as virtual processor capacity, logical disk space, and logical RAM capacity. Accordingly, the computing resources provided by a hardware component can correspond to the physical resources of computing device(s), while the computing resources provided by a service component can correspond portions of cloud system resources allocated to the service component (e.g., logical group(s) of computing resources from the cloud system). In some implementations, the target virtual machine instances implemented by the hardware components are hosted at the hardware devices corresponding to the hardware components and the target virtual machine instances implemented by the service components are hosted across a plurality of device of the cloud service provider.

In some implementations, generating the shape for the target architecture includes interrogating one or more of the target hardware components and/or the target service components that are implemented prior to migration of the source digital elements. The interrogating can derive information about the one or more target hardware components and/or target service components (e.g., by executing one or more reverse engineering scripts on a hardware device and/or cloud system that implements the one or more target hardware components and/or target service components) to retrieve hardware attributes and/or service attributes. For example, the generated shape for the target architecture can be based on the retrieved hardware attributes and/or service attributes.

In some implementations, generating the shape for the target architecture can include mapping source digital elements to target hardware components and/or target service components of the target architecture. For example, a plurality of mapping scenarios that map the classified source digital elements to target hardware components and/or target service components of the target architecture can be generated. The mapping scenarios can be generated based on the resource requirements for the source digital elements and parameters for the source digital elements (e.g., a location parameters of the source digital elements, a security zone parameter of the source digital elements, an environment parameters for the source digital elements, etc.), wherein the target architecture is configured to receive migration data for the digital elements and operate the digital elements via the target virtual machine instances. The target architecture can be configured to receive migration of the source digital elements and operate target digital elements, via the target hardware components and/or target service components, corresponding to the source digital elements.

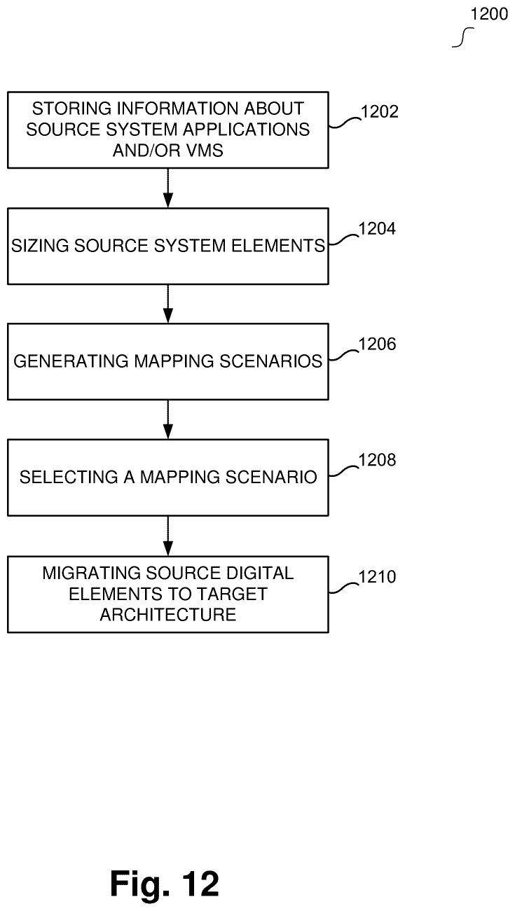

In some implementations, the source digital elements can be migrated from the source system to the target hardware components and/or target service components of the target architecture according to one of the mapping scenarios. Process 1200 of FIG. 12 further describes techniques to map source digital elements to a target architecture.

FIG. 12 illustrates a flow diagram for performing digital migration of applications and/or virtual machines using consolidation according to an example embodiment. At block 1202, process 1200 can store information about a plurality of source digital elements from a source system. Example source digital elements include applications and/or virtual machines. In some implementations, the received information can include source architecture types for the source digital elements (e.g., type of virtual environment/virtual machine), processor utilization for the source digital elements, memory utilization for the source digital elements, digital element disk size, target cut-over time, or any other suitable information. In some implementations, parameters for the source digital elements can also be stored. Example parameters include a location, a security zone, an environment, or any other suitable parameters.

At block 1204, process 1200 can size each of the plurality of source digital elements. For example, the source digital elements can be sized according to the processor utilization and memory utilization for the source digital elements to determine resource requirements at a target system. In some implementations, the determined resource requirements for the sized source digital elements define a memory size range and processor utilization range for each source digital element.

At block 1206, process 1200 can generate a plurality of mapping scenarios that map the classified source digital elements to target pools of capacity, at a target architecture, using consolidation policies. In some implementations, the target architecture can comprise target hardware components and/or target service components, and the pools of capacity being assigned to the target hardware components and/or the target service components.

The consolidation policies can map the source digital elements to the pools of capacity based on the resource requirements for the source digital elements, the location parameters of the source digital elements, and the security zone parameters of the source digital elements. The pools of capacity can comprise pool parameters including at least a first parameter that corresponds to the location parameters and a second parameter that corresponds to the security zone parameter. The consolidation policies can define matching rules such that an unmapped digital element can be mapped to a given pool of capacity when parameters for the unmapped digital element match parameters for the given pool of capacity.

In some implementations, the plurality of mappings scenarios are generated by iteratively mapping the source digital elements to the pools of capacity using variations of the consolidation policies. The target architecture can be configured to receive migration of the source digital elements and operate target digital elements, via the pools of capacity at the target architecture, corresponding to the source digital elements.

In some implementations, for a first iteration that utilizes a first variation of the consolidation policies, an unmapped digital element is mapped to a given pool of capacity when parameters for the unmapped digital element match parameters for the given pool of capacity according to the first variation of the consolidation policy. The variations of the consolidation policies can define different rule sets that determine matches between parameter values for the digital elements and parameter values for the pools of capacity. In this example, for a given parameter, a first variation of the consolidation policies can comprise a first ruleset that defines digital element parameter values that match to pool parameter values, and, for the given parameter, a second variation of the consolidation policies can comprise a second ruleset that defines digital element parameter values that match to pool parameter values, the first ruleset being different from the second ruleset.

In some implementations, the mapping scenarios can comprise different mappings of source digital element to the pools of capacity. In some implementations, the mapping scenarios can comprise different sizes of the pools of capacity at the target architecture.

At block 1208, process 1200 can select a mapping scenario for the digital element migration. For example, a mapping scenario can be selected that optimizes operational characteristics for the target virtual machine instances and the migrated digital elements.

In some implementations, the mapping scenarios can be analyzed to generate consolidation summaries. For example, each consolidation summary can include a utilization metric of the target architecture for the corresponding mapping scenario and/or one or more source digital elements that remain unmapped in the corresponding mapping scenario. The mapping scenario can be selected according to a) a user selection of the one mapping scenario from the plurality of mapping scenarios, or b) a ranking of the utilization metrics of the target architectures for the mapping scenarios.

In some implementations, after generating the mapping scenarios, alterations to the target hardware components and/or the target service components of the target architecture can be received. For example, a user may, in response to the consolidation summary and/or unmapped source digital elements, alter the target hardware components and/or the target service components that comprise the target architecture, such as add new target hardware components and/or the target service components, remove existing target hardware components and/or the target service components, expand existing target hardware components and/or the target service components, shrink existing target hardware components and/or the target service components, and the like.

After such alterations are receive, second mapping scenarios can be generated for the target architecture using the altered target hardware components and/or the target service components of the target architecture. The alteration(s) to the target hardware components and/or the target service components can change the way source digital elements are mapped to the target architecture, such as change the consolidation summaries and/or unmapped source digital element(s). In some implementations, the selected mapping scenario can be one of the second mapping scenarios.

At block 1210, process 1200 can migrate the source digital elements to the target architecture. For example, the source digital elements can be migrated from the source system to the pools of capacity at the target architecture according to the selected mapping scenario.

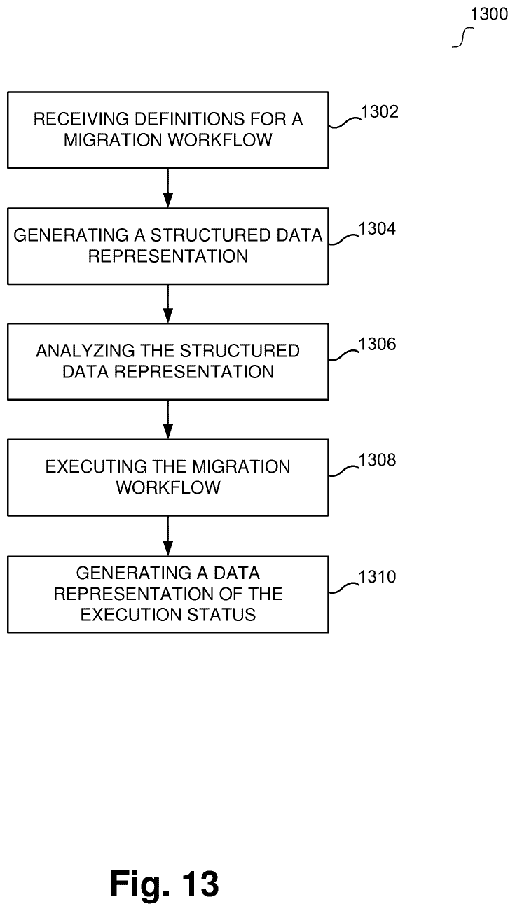

FIG. 13 illustrates a flow diagram for performing digital migration of applications and/or virtual machines using workflow definitions. At block 1302, process 1300 can receive definitions for a migration workflow that migrates digital elements from a source architecture to a target architecture. For example, the digital elements can include applications and/or virtual machines. The received definitions can comprise labels for a plurality of sub-components of the migration workflow, parameters that correspond to each of the sub-components, resource locators that corresponds to one or more scripts for the sub-components, and a predefined order for at least a portion of the sub-components.

At block 1304, process 1300 can generate a structured data representation of the received definitions for the migration workflow. For example, the structured data representation of the received definitions can be a JavaScript Object Notation (JSON) file, a markup language data file, a data file that organizes the sub-components according to tags, or a data file that organizes the sub-components according to name-value relationships, arrays, or serializable data values.

At block 1306, process 1300 can analyze the structured data representation. For example, the structured data representation can be analyzed to: parse the structured data representation, and extract entities and values for each of the defined sub-components. In some implementations, the extracted entities and values can include script commands and parameters for the script commands. Analyzing the structured data representation can also include building a set of script commands using the extracted entities and values.

In some implementations, analyzing the structured data representation can include generating commands for performing the migration workflow. For example, generating the commands can include analyzing, via the one or more migration engines, the structured data representation to: parse the structured data representation, and extract entities and values for each of the defined sub-components, where the extracted entities and values comprise at least script commands and parameters for the script commands. The extracted entities and values can be used to build a set of script commands.

At block 1308, process 1300 can execute the migration workflow. For example, one or more migration engines can execute the migration workflow to migrate digital elements from source architecture to target architecture. The execution of the migration workflow can include: a) performing the sub-components of the migration workflow at least by running the one or more scripts for the sub-components via the resource locators, where the portion of the sub-components is performed in the predefined order, and b) populating one or more execution status data files that represent a status of the executing.

In some implementations, executing the migration workflow can include execute a built set of script commands. For example, executing the set of script commands can include executing script commands corresponding to the portion of sub-components according to a predefined order defined via the definitions for the migration workflow. In some implementations, the definitions can include an execution label for the sub-components, first script commands can correspond to sub-components that comprise a synchronous execution label, and second script commands can correspond to sub-components that comprise an asynchronous execution label. For example, executing the migration workflow can include executing the first script commands in sequence and executing one or more of the second script commands in parallel with the first script commands. In some implementations, the first script commands correspond to a portion of the sub-components that comprise an order, and the synchronous execution of the first script commands is performed according to the order.

At block 1310, process 1300 can generate a structured data representation of the execution status. For example, the execution status data files can be accessed and processed to generate the structured data representation.

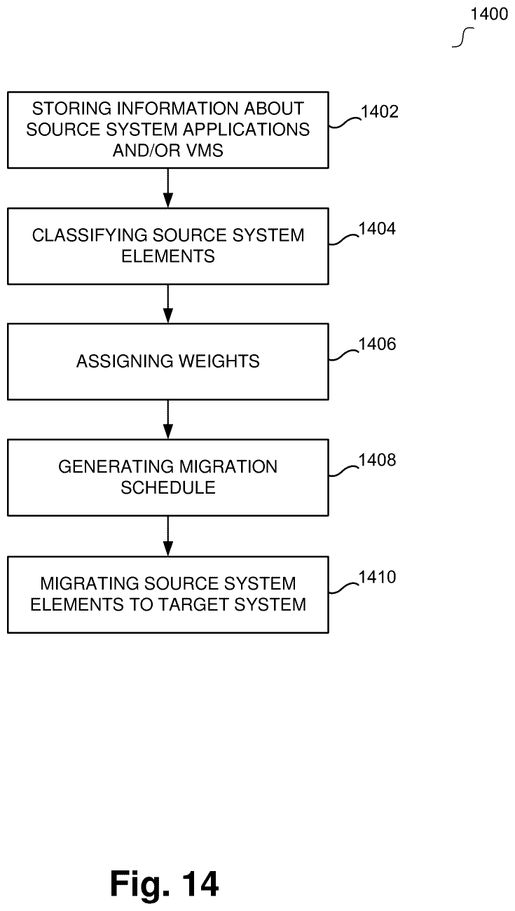

FIG. 14 illustrates a flow diagram for performing rule-based scheduling and migration of applications and/or virtual machines based on complexity and weight according to an example embodiment. At block 1402, process 1400 can store information about a plurality of source digital elements from a source system. Example source digital elements include applications and/or virtual machines. In some implementations, the received information can include source architecture types for the source digital elements (e.g., type of virtual environment/virtual machine), processor utilization for the source digital elements, memory utilization for the source digital elements, digital element disk size, target cut-over time, or any other suitable information.

At block 1404, process 1400 can classify each of the plurality of digital elements to one of a plurality of predetermined migration complexities. For example, the digital elements can be classified to predetermined migration complexity classes based on the processor utilization, downtime information for the source, and any other suitable information for the digital elements. Example digital element predetermined migration complexity classifications include very simple, simple, average, complex, very complex, and the like, or any other suitable predetermined classifications.

At block 1406, process 1400 can assign scheduling weights to the migration complexity classes. For example, scheduling weights can be assigned (e.g., via a user or by any other suitable manner) to the predetermined migration complexity classifications, and each digital element can comprise the scheduling weight assigned to its classification.

At block 1408, process 1400 can generate a migration schedule that defines periods of time for migrating the digital elements from the source system to target virtual machine instances of target architecture. For example, a rule-based scheduling engine can generate the migration schedule based on applying scheduling rules to the classified predetermined migration complexities for the source digital elements and the scheduling weights to assign source digital elements to the periods of time. The periods of times can be days, weeks, months, or any other suitable periods of time.

In some implementations, the scheduling rules define a weight criteria for the periods of time. For example, the weight criteria can be a threshold aggregate weight for a given period of time, and the rules based scheduling engine can generate the migration schedule such that an aggregate weight of classified digital elements assigned to the given period of time is less than or equal to the weight criteria. In some implementations, the rules define a threshold number of migrations for the given period of time, and the rules based scheduling engine can generate the migration schedule such that a total number of digital elements assigned to the given period of time is less than or equal to the threshold number of migrations.

In some implementations, dependent databases can be identified for a portion of the source digital elements, and the dependent databases can be scheduled for migration with the portion of source digital elements. For example, each of the plurality of dependent databases can be classified to one of a plurality of predetermined database migration complexities. In some implementations, each of the predetermined migration complexity classes can have a corresponding database scheduling weight. For example, scheduling weights can be assigned (e.g., via a user or by any other suitable manner) to the predetermined database migration complexity classifications, and each dependent database can comprise the scheduling weight assigned to its classification.

In some implementations, the rule-based scheduling engine can generate the migration schedule based on applying scheduling rules to: a) the classified predetermined migration complexities for the source digital elements, b) the scheduling weights, c) the classified predetermined database migration complexities for the dependent databases, and d) the database scheduling weights to assign the portion of source digital elements and their database dependencies to the periods of time. The generated migration schedule can assign a given source digital element of the portion of source digital elements to a same period of time as the dependent databases for the given source digital element.

In some implementations, a weight criteria comprises a threshold aggregate weight for a given period of time, and the rules based scheduling engine can generate the migration schedule such that an aggregate weight of classified source digital elements and dependent databases assigned to the given period of time is less than or equal to the weight criteria. In some implementations, the rules define a threshold number of migrations for the given period of time, and the rules based scheduling engine generates the migration schedule such that a total number of digital elements and dependent databases assigned to the given period of time is less than or equal to the threshold number of migrations. In some implementations, the rules based scheduling engine can generate a migration schedule such that an aggregate weight of classified source digital elements and dependent databases assigned to a given period of time is less than or equal to the weight criteria and that a total number of digital elements and dependent databases assigned to the given period of time is less than or equal to the threshold number of migrations.

At block 1410, process 1400 can migrate the source digital elements to the target architecture. For example, each source digital element can be assigned to one of a plurality of periods of time, and the source digital elements can be migrated from the source system to the target virtual machine instances during the assigned period of time per source digital element.

In some implementations, digital elements can be migrated to and/or from systems that comprise diverse components. For example, the source system and/or target system involved in the migration can comprise a mix of on-premise assets, cloud assets, assets from multiple cloud services providers, and any other suitable computing assets that can host virtual machine instances and/or software applications.

Embodiments plan, schedule, and execute digital element migration between a source system and a target system. For example, a source system can include a number of source assets (e.g., one or a mix of on-premise, cloud, Oracle®, and the like) that operate digital elements, such as applications and/or virtual machines. Migration of the digital elements from the source system to a new system (e.g., target system) can sometimes be performed, for example to improve operational efficiency or for any other suitable purpose.

In some implementations, the source system can be implemented by an enterprise or organization, and the digital elements can provide software functionality for the enterprise or organization. For example, once the digital elements are migrated from the source system to the target system, this functionality can be accomplished via operating the digital elements at the target system. Examples of such software applications/functionality include accounting, inventory management, information technology, back-end data services, cloud hosting for a web application, software as a service, infrastructure as a service, platform as a service, product specific functionality, service specific functionality, identity management services, and any other suitable software functionality.

Implementations can perform the digital element migration using digital element sizing and target architecture shaping. For example, the digital elements can be sized to determine resource requirements for the digital elements. The sized digital elements can then support shaping of virtual machine instances for the target system, mapping of the digital elements to the virtual machine instances for the target system, and migration scheduling.

In some implementations, new migration workflows can be customized via provided definitions. For example, the provided definitions can include script indicators, parameters for script indicators, and an organization of sub-components of the new migration workflow. The definitions can then be processed to create intermediate versions (e.g., structured data representation(s), sets of commands, and the like) to execute the migration workflow. Migrating the source digital elements to the target virtual machines instances can be accomplished, in part, by executing the newly defined migration workflow.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

We claim:

1. A method for performing digital migration of applications and/or virtual machines using source sizing and target shaping, the method comprising:
receiving information about a plurality of source digital elements associated with a source system, the information comprising processor utilization for the source digital elements and memory utilization for the source digital elements, wherein the source digital elements comprise applications and/or virtual machines;
sizing the source digital elements according to the processor utilization and memory utilization to determine resource requirements at a target system; and
generating a shape for a target architecture based on the resource requirements for the source digital elements, the shape comprising a plurality of target virtual machine instances implemented by target hardware components and/or target service components of the target architecture, wherein the target architecture is configured to receive migration of the source digital elements and operate target digital elements, via the target virtual machine instances, corresponding to the source digital elements.

2. The method of claim 1, wherein the determined resource requirements for the sized source digital elements define a memory size range and processor utilization range for each source digital element.

3. The method of claim 1, further comprising:
interrogating the source system to derive information about the plurality of source digital elements by executing one or more reverse engineering scripts on the source system to retrieve the processor utilization per source digital element.

4. The method of claim 1, wherein the target hardware components correspond to hardware devices comprising hardware attributes and the target service components correspond to logical computing services comprising service attributes.

5. The method of claim 4,
wherein the hardware attributes comprise computing resources of the corresponding hardware device, the computing resources comprising physical processor capacity, physical disk space, and physical RAM capacity,
wherein the service attributes comprise cloud computing resources from a cloud service provider, the cloud computing resources comprising virtual processor capacity, logical disk space, and logical RAM capacity.

6. The method of claim 5,
wherein the target virtual machine instances implemented by the hardware components are hosted at the hardware devices corresponding to the hardware components, and
wherein the target virtual machine instances implemented by the service components are hosted across a plurality of device of the cloud service provider.

7. The method of claim 4, wherein generating the shape for a target architecture further comprises:
interrogating one or more of the target hardware components and/or the target service components that are implemented prior to migration of the source digital elements,
wherein the interrogating derives information about the one or more target hardware components and/or target service components by executing one or more reverse engineering scripts on a hardware device and/or cloud system that implements the one or more target hardware components and/or target service components to retrieve hardware attributes and/or service attributes, and
wherein the generated shape for the target architecture is based on the retrieved hardware attributes and/or service attributes.

8. The method of claim 4, further comprising:
generating a plurality of mapping scenarios that map the classified source digital elements to the target hardware components and/or target service components of the target architecture based on the resource requirements for the source digital elements and parameters for the source digital elements, wherein the target architecture is configured to receive migration of the source digital elements and operate target digital elements, via the target hardware components and/or target service components, corresponding to the source digital elements; and
migrating the source digital elements from the source system to the target hardware components and/or target service components of the target architecture according to one of the mapping scenarios.

9. A non-transitory computer readable medium having instructions stored thereon that, when executed by a processor, cause the processor to perform digital migration of applications and/or virtual machines using source sizing and target shaping, wherein, when executed, the instructions cause the processor to:
receive information about a plurality of source digital elements associated with a source system, the information comprising processor utilization for the source digital elements and memory utilization for the source digital elements, wherein the source digital elements comprise applications and/or virtual machines;
size the source digital elements according to the processor utilization and memory utilization to determine resource requirements at a target system; and
generate a shape for a target architecture based on the resource requirements for the source digital elements, the shape comprising a plurality of target virtual machine instances implemented by target hardware components and/or target service components of the target architecture, wherein the target architecture is configured to receive migration of the source digital elements and operate target digital elements, via the target virtual machine instances, corresponding to the source digital elements.

10. The non-transitory computer readable medium of claim 9, wherein the determined resource requirements for the sized source digital elements define a memory size range and processor utilization range for each source digital element.

11. The non-transitory computer readable medium of claim 9, wherein, when executed, the instructions further cause the processor to:
interrogate the source system to derive information about the plurality of source digital elements by executing one or more reverse engineering scripts on the source system to retrieve the processor utilization per source digital element.

12. The non-transitory computer readable medium of claim 9, wherein the target hardware components correspond to hardware devices comprising hardware attributes and the target service components correspond to logical computing services comprising service attributes.

13. The non-transitory computer readable medium of claim 12,
wherein the hardware attributes comprise computing resources of the corresponding hardware device, the computing resources comprising physical processor capacity, physical disk space, and physical RAM capacity,
wherein the service attributes comprise cloud computing resources from a cloud service provider, the cloud computing resources comprising virtual processor capacity, logical disk space, and logical RAM capacity.

14. The non-transitory computer readable medium of claim 13,
wherein the target virtual machine instances implemented by the hardware components are hosted at the hardware devices corresponding to the hardware components, and
wherein the target virtual machine instances implemented by the service components are hosted across a plurality of device of the cloud service provider.

15. The non-transitory computer readable medium of claim 12, wherein generating the shape for a target architecture further comprises:
interrogating one or more of the target hardware components and/or the target service components that are implemented prior to migration of the source digital elements,
wherein the interrogating derives information about the one or more target hardware components and/or target service components by executing one or more reverse engineering scripts on a hardware device and/or cloud system that implements the one or more target hardware components and/or target service components to retrieve hardware attributes and/or service attributes, and
wherein the generated shape for the target architecture is based on the retrieved hardware attributes and/or service attributes.

16. The non-transitory computer readable medium of claim 12, wherein, when executed, the instructions further cause the processor to:
generate a plurality of mapping scenarios that map the classified source digital elements to the target hardware components and/or target service components of the target architecture based on the resource requirements for the source digital elements and parameters for the source digital elements, wherein the target architecture is configured to receive migration of the source digital elements and operate target digital elements, via the target hardware components and/or target service components, corresponding to the source digital elements; and
migrate the source digital elements from the source system to the target hardware components and/or target service components of the target architecture according to one of the mapping scenarios.

17. A system for performing digital migration of applications and/or virtual machines using source sizing and target shaping, the system comprising:
a processor; and
a memory storing instructions for execution by the processor, the instructions configuring the processor to:
receive information about a plurality of source digital elements associated with a source system, the information comprising processor utilization for the source digital elements and memory utilization for the source digital elements, wherein the source digital elements comprise applications and/or virtual machines;
size the source digital elements according to the processor utilization and memory utilization to determine resource requirements at a target system; and
generate a shape for a target architecture based on the resource requirements for the source digital elements, the shape comprising a plurality of target virtual machine instances implemented by target hardware components and/or target service components of the target architecture, wherein the target architecture is configured to receive migration of the source digital elements and operate target digital elements, via the target virtual machine instances, corresponding to the source digital elements.

18. The system of claim 17, wherein the determined resource requirements for the sized source digital elements define a memory size range and processor utilization range for each source digital element.

19. The system of claim 17, wherein the instructions further configure the processor to:
interrogate the source system to derive information about the plurality of source digital elements by executing one or more reverse engineering scripts on the source system to retrieve the processor utilization per source digital element.

20. The system of claim 17,
wherein the target hardware components correspond to hardware devices comprising hardware attributes and the target service components correspond to logical computing services comprising service attributes,
wherein the hardware attributes comprise computing resources of the corresponding hardware device, the computing resources comprising physical processor capacity, physical disk space, and physical RAM capacity,
wherein the service attributes comprise cloud computing resources from a cloud service provider, the cloud computing resources comprising virtual processor capacity, logical disk space, and logical RAM capacity.
